(19) United States
(12) Patent Application Publication
(10) Pub. No.: US 2017/0183255 A1
(43) Pub. Date: Jun. 29, 2017

(54) COATED CHEMICALLY STRENGTHENED FLEXIBLE THIN GLASS

(71) Applicant: Schott AG, Mainz (DE)

(72) Inventors: Marten Walther, Alfeld (DE); Marta Krzyzak, Bad Gandersheim (DE); Dirk Apitz, Lausanne (CH); Jochen Alkemper, Klein-Winternheim (DE)

(73) Assignee: Schott AG, Mainz (DE)

(21) Appl. No.: 15/455,759

(22) Filed: Mar. 10, 2017

Related U.S. Application Data
(63) Continuation of application No. PCT/EP2015/068530, filed on Aug. 12, 2015.

(30) Foreign Application Priority Data
Sep. 12, 2014 (DE) 10 2014 013 550.0

(51) Int. Cl. C03C 17/25; C03B 17/06; C09D 5/00; C03C 3/093; C03C 4/18; C03C 21/00; C03C 3/091

(52) U.S. Cl. CPC C03C 17/25; C03C 21/002; C03B 17/06; C03C 3/091; C03C 3/093; C03C 4/18; C09D 5/002; C03C 2217/76; C03C 2218/113; C03C 2204/00

(57) ABSTRACT

A coated chemically strengthened flexible thin glass includes a coating of an adhesive layer in the form of a silicon mixed oxide layer, which contains or consists of a silicon oxide layer in combination with at least one oxide of aluminum, tin, magnesium, phosphorus, cerium, zirconium, titanium, cesium, barium, strontium, niobium, zinc, or boron, and magnesium fluoride, such as at least aluminum oxide.

### CROSS REFERENCE TO RELATED APPLICATIONS

This is a continuation of PCT application No. PCT/EP2015/068530, entitled “COATED CHEMICALLY STRENGTHENED FLEXIBLE THIN GLASS”, filed Aug. 12, 2015, which is incorporated herein by reference.

### BACKGROUND OF THE INVENTION

1. Field of the Invention

The invention relates to a coated chemically strengthened flexible thin glass that can be used for flexible electronic devices, sensors for touch panels, substrates for thin-film cells, mobile electronic devices, interposers, bendable displays, solar cells or other applications requiring high chemical stability, temperature stability and flexibility, as well as low thickness.

2. Description of the Related Art

Thin or ultra-thin glass of different compositions is a suitable substrate material for many applications where chemical and physical properties, such as transparency, chemical and thermal durability, are of great significance. For example, non-alkaline glasses, such as AF32®, AF37®, AF45® by SCHOTT, can be used for display screens and wafers as so-called electronic packaging materials. Borosilicate glass can also be used as fire prevention for thin- and thick film sensors, laboratory utensils and lithographic masks.

Thin or ultra-thin glass is typically used in electronic applications, such as films and sensors. Today, the increasing requirement for new functionalities of products and exploitation of new and broad applications demand thinner and lighter glass substrates with new properties, such as flexibility.

Thin glass is typically produced by reducing or grinding down a thicker glass, for example borosilicate glass. However, glass layers having a thickness of less than 0.5 mm due to reduction or grinding down and polishing of thicker glass layers are not available and can be produced only under extremely restrictive conditions. Glass that is thinner than 0.3 mm, or even 0.1 mm, such as D263®, MEMpax®, BF33®, BF40®, B270® by SCHOTT can be produced by a downdraw method. Soda-lime glass having a thickness of 0.1 mm can be produced, for example, by a special float method.

The greatest challenge in the use of thin glass substrates in electronic devices is the treatment of the thin glass layers. Normally, the glass is missing ductility and the potentiality of a break depends largely on the mechanical strength of the layer. For thin glass, several methods have been suggested for this. U.S. Pat. No. 6,815,979 (Mauch et al) suggests, for example, coating of thin glass with organic or polymer films in order to improve the breaking strength of the glass. This method leads to some disadvantages. For example, the improvement in strength is not sufficient and a few very special processes have to be performed if the glass layers are to be cut. In addition, the polymer coating has a negative effect upon the thermal durability and the optical properties of the glass layers.

Chemical tempering or strengthening is a well-known method for increasing the strength of a thicker glass, such as soda-lime glass or aluminosilicate glass (AS glass) that is used, for example, as cover glass for display applications. Under these conditions, the internal surface stress or the surface compressive stress (CS) is normally between 600 and 1000 MPa and the thickness or depth of the ion exchange layer (DoL) is typically greater than 30 μm, such as greater than 40 μm. When used in safety covers in transportation and aviation, the AS glass can have an exchange layer of greater than 100 μm. Normally a glass with higher CS and higher DoL is suitable for any application, if the glass thickness of between approximately 0.5 to 10 mm is sufficient. Because of the high tensile stress due to the high CS with concurrent great DoL, thin or ultrathin glass however tends to break of its own accord so that new parameters must be introduced for thin or ultrathin glass, that are different than those for covers of normal thickness.

Studies were conducted regarding chemical strengthening or chemical tempering of glass in various publications:

US 2010/0009154, for example, describes a glass having a thickness of 0.5 mm or more with an outer region of compressive stress, wherein the outer region has a depth of at least 50 μm and the compressive stress is at least higher than 200 MPa, wherein the step of creating the central tensile stress (CT) and the compressive stress in the surface region includes consecutive dipping of a component of the glass into a multitude of ion exchange baths. The obtained glass is used for consumer electronics. The described parameter and challenge for the producer of such a glass are not suitable for producing thin glass, because the tensile stress would be so high that the glass would break.

US 2011/0281093 describes a tempered glass that is resistant against damage, wherein the tempered glass object has opposing first and second compressive stress surface regions that are connected to one another by a tensile stress core region, wherein the first surface region has a higher degree of compressive stress than the second surface region in order to improve resistance against surface damage. The compressive stress surface regions are provided through laminating, ion exchange, tempering or combination thereof, to control the tension profile and to limit the breaking energy of the objects.

WO 11/149694 discloses a glass with an antireflective coating that is chemically tempered, wherein the selected coating is present on at least one surface of the glass object and is selected from the group consisting of one antireflective and/or antiglare coating. The coating contains at least 5 weight-% potassium oxide.

US 2009/197048 discloses a chemically strengthened glass that has a functional coating to serve as a cover plate. The glass object has a surface compressive stress of at least approximately 200 MPa, a surface compressive stress layer depth in the region of 20 to 80 μm and has an amphiphobic surface layer on fluorine basis that is chemically bound to the surface of the glass object, to form a coated glass object.

In U.S. Pat. No. 8,232,218 a heat treatment was used to improve the effects of chemical strengthening of the glass. The glass object has an annealing temperature and a deformation temperature, whereby the glass object is chilled from a first temperature that is higher than the formation temperature to a second temperature that is lower than the formation temperature. After chemical tempering, the rapidly cooled glass has a higher compressive strength and a thicker ion exchange layer.

In US 2012/0048604 the ion-exchanged thin aluminosilicate or alumino-borosilicate layer is used as an interposer for electronic devices. The interposer comprises a glass substrate fore, formed by an ion-exchanged glass. The coefficient of thermal expansion (CTE) is adjusted to coincide with that of the semiconductors and metallic materials and suchlike. However, in that patent application, a compressive stress on the surface of more than 200 MPa is necessary, and the depth of the layer for the aluminosilicate or alumino-borosilicate is very great. The above factors make it difficult for the glass to be functionally used. The flexibility of glass and how same could be approved is not considered. In addition, the chemical tempering process requires dipping of a glass substrate into a glass bath at high temperature and the method would require that the glass itself has high Δ resistance. No mention is made in the entire disclosure as to how the glass composition and the relevant functions are to be adjusted to meet these requirements.

For thin glass, self-breaking, for example, is a serious problem, in particular for aluminosilicate glass because the high CTE of aluminosilicate glass reduces the thermal shock resistance and increases the possibility of a fracture for thin glass during the strengthening process and other treatments. Most aluminosilicate glasses also have a higher CTE that is not consistent with that of electronic semiconductors, which causes problems during treatment and use.

An additional problem with thin glasses is the limited long-term durability of the applied layers, so that the functionalities provided by the layers are quickly lost due to chemical and/or physical attack. The functionalities that are preferred in applications for touch screens are, for example a smooth contact surface, high transparency, low reflection characteristic, increased scratch and abrasion strength, for example, when using styluses, high dirt repellency and easy cleanability through the so-called “easy-to-clean” properties, in particular regarding resistance against finger sweat that contains salts and fats through so-called “anti-fingerprint” properties, as well as durability of a coating, even in the case of climatic and UV stress and resistance against many cleaning cycles. The durability or stability depends not only on the type of the selected coating, but also on the substrate surface upon which the coating is applied.

What is needed in the art is a thin, flexible glass that overcomes some of the aforementioned problems of known glasses. Particularly, the thin glass may possess increased strength to be used in a suitable manner; and increased long-term durability for functional coating that is to be applied thereupon. Furthermore, production of such glasses should be as cost effective and should be possible in a simple manner.

### SUMMARY OF THE INVENTION

The present invention, in one exemplary embodiment, provides a coated, chemically strengthened flexible thin glass, including, as a coating, an adhesion promoting layer in the form of a silicon mixed oxide layer which contains or consists of a silicon oxide layer in combination with at least one oxide of aluminum, tin, magnesium, phosphorus, cerium, zirconium, titanium, caesium, barium, strontium, niobium, zinc, boron and/or magnesium, such as at least aluminum oxide.

A flexible glass substrate is therefore produced, whose flexibility can be increased by chemical strengthening wherein, through the provision of a special adhesion promoting layer, the long-term stability of an applied functional coating on the glass substrate can be improved. In addition, the composition of the thin or ultrathin flexible glass can be specially selected to provide excellent thermal shock resistance for chemical strengthening and for practical use. The flexible thin or ultrathin glass of the present invention can have lower compressive stress and lesser depth of the compressive stress layer after chemical strengthening compared with other glasses. Such properties render the glass layer or glass plate of the present invention suitable for practical processing.

In one exemplary embodiment of the present invention, a coated chemically strengthened thin or ultrathin glass with high flexibility, thermal shock resistance, transparency and long-term durability of the coating can be provided.

The thickness of the glass can be 2 mm or less, such as 1.2 mm or less, 500 μm or less, 400 μm or less, or 300 μm or less. Within the context of the present invention, a glass is defined as “an ultrathin glass” if the glass has a thickness of 300 μm or less.

For an ultrathin glass with a thickness of 300 μm or less, an ion exchanged layer of a thickness of 30 μm or less and a central tensile stress of 120 MPa or less can provide useful properties. The glass can have a low thermal coefficient of expansion (CTE) and a low Young's modulus to improve the thermal shock resistance and the flexibility. In addition, the low CTE of the glass results in that it harmonizes well with the CTE of semiconductor devices and inorganic materials, and that excellent properties and improved practicability is achieved.

In one exemplary embodiment, the glass is an alkaline glass, such as a lithium-aluminosilicate glass, a soda-lime silicate glass, a borosilicate glass, an alkali-aluminosilicate glass and a low alkali glass.

According to one embodiment of the present invention, a novel glass is produced. The glass contains alkali to enable the ion exchange and chemical strengthening. In the case of ultrathin glass, the depth of the ion exchange layer (DoL) can be controlled such that it is less than 30 μm and the CS can be controlled to be below 700 MPa. The glass is coated with an adhesion promoting layer including a silicon mixed oxide layer, so that one or several additional layers can be applied that will provide the glass with one or with several properties.

Another exemplary embodiment of the present invention provides a coated thin flexible glass that has a CTE of less than 10×10⁻⁶/K, as well as a Young's modulus of less than 84 GPa in order to realize excellent thermal shock resistance and flexibility.

Yet another exemplary embodiment of the present invention is a method for the production of the glass. The starting glass can be produced through a downdraw method, overflow fusion, a special float or redrawing method or grinding or etching from a thicker glass. The starting glass can be produced in the form of layers or plates or rolls. The starting glass can have a surface with a roughness Rₐ of less than 50 nm, and one or both surfaces of the glass can be subjected to an ion exchange and are thus chemically strengthened. The adhesion promoting layer and, if required, additional functional layers can be applied thereupon before or after chemical strengthening. The coated chemically tempered or respectively strengthened thin glass can be used for roll-to-roll processing.

Yet another exemplary embodiment of the present invention provides a glass object with additional functions, whereby functional layers are applied onto the adhesion promoting layer that is disposed on the glass, with or without intermediate layers. Functional layers can be layers that provide the desired properties for the intended use. According to one exemplary embodiment, one or several functional layers can be applied optionally onto the adhesion promoting layer by using one or several intermediate layers.

The functional layers can be selected, for example, from anti-fingerprint layers, for example based on an amphiphobic fluoro-organic surface layer as described in WO 2009/099615 A1; easy-to-clean layers as disclosed, for example, in WO 2012/163947 A1 and WO2012/163946 A1; optically active layers, for example antireflective and/or antiglare layers, as disclosed in WO2011/149694 A1; anti-scratch layers, as described for example in WO 2012/177563 A2 or WO 2012/151097 A1; or conductive layers, cover layers, protective layers, abrasion resistant layers, antibacterial or antimicrobial layers, colored layers and suchlike. All cited references are incorporated herein by reference.

In one exemplary embodiment, a conductive coating is applied onto the adhesion promoting layer which is not based on indium tin oxide (non-ITO); the coating serves as a flexible or bendable conductive film. This can be used in flexible sensors or flexible circuit boards or displays.

In another exemplary embodiment, optically active coatings can be applied onto the adhesion promoting layer which provide high transparency at a low reflective behavior, such as antireflective or anti-glare layers.

In another exemplary embodiment of the present invention, a coating is applied onto the adhesion promoting layer that has high dirt repellency and easy cleanability, realized by easy-to-clean-coatings. An additional coating with resistance against chemical stress caused by finger sweat that contains salts and fats is a so-called anti-fingerprint coating.

For touchscreen applications, layers with functionalities that cause the improvement of tactile and haptic perceptibility of the contact surface, in other words smooth coatings, can be used.

In another exemplary embodiment, a coating is used that is scratch- and abrasion resistant, for example, when styluses are used on touchscreens.

According to another exemplary embodiment, a coating is used that is especially suitable for use in cases of climatic and UV stress.

In addition to the described functional layers, one or both surfaces of the thin glass can be pretreated in another exemplary embodiment, such as polished or textured, for example etched, depending on what surface properties are required; for example, to fulfill the requirements of a better feel, such as better sense of touch and to be visually more pleasant.

Such a coated, chemically strengthened thin flexible glass layer that, due to the present adhesion promoting layer, possesses an especially good long-term stability of the functional coating provided thereupon, finds varies use, for example, for mobile telephones, tablets, laptops, resistive touch panels, TVs, mirrors, windows, aircraft windows, furniture and household appliance applications and suchlike.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 illustrates the CD and DoL profiles of the thin glass of the present invention, after being chemically strengthened;

FIG. 2 illustrates the improvement of the flexibility of the thin glass of the present invention, after chemical strengthening;

FIG. 3 illustrates the improvement of the Weibull-distribution of the thin glass of the present invention after chemical strengthening; and

FIG. 4 illustrates an exemplary embodiment of a thin, chemically tempered flexible glass of the present invention on which an adhesion promoting layer, without additional intermediate layers, and a functional layer are applied directly onto the glass, resulting in a higher long-term stability of the functional layer.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION OF THE INVENTION

As used herein, “compressive stress” (CS) according should be understood to be the stress that results from the displacement effect upon the glass network through the glass surface after an ion exchange, while no deformation occurs in the glass, measured with the commercially available stress meter FSM6000, based on optical principles.

“Depth of ion exchanged layer” (DoL) should be understood to be the thickness of the glass surface layer where ion exchange occurs and compressive stress is produced. The DoL can be measured with the commercially available stress meter FSM6000, based on optical principles.

“Central tensile stress” (CT) should be understood to be the tensile stress that is produced in the intermediate layer of glass and which counteracts the compressive stress that is produced between the upper and the lower surface of the glass after the ion exchange. The CT can be calculated by measuring the CS and the DoL

“Average roughness” (Rₐ) should be understood to be the roughness whereby the processed surfaces have smaller intervals and tiny height- and depth unevenness; the average roughness Rₐ is the arithmetic average value of the material surface profile deviation of the absolute values inside the sample length. Rₐ can be measured with a scanning electron microscope.

“Coefficient of thermal conductivity (λ)” should be understood to be the ability of the substances to conduct heat. λ can be measured with a commercially available thermal conductivity measuring device.

“Strength of materials (σ)” should be understood to be the maximum stress that can be withstood by the materials before a break occurs. σ can be measured in a three-point or four-point bending test. In this sense, σ is defined as the average value over a series of tests.

“Poisson's ratio of materials (μ)” is the ratio of transverse stress to longitudinal stress of materials under stress. μ can be measured by tests whereby stress is exerted on the materials and the stresses are recorded.

“Gloss” is the ratio of the amount of light reflected from the surface of the materials relative to the amount of light reflected from the surface of a standard test specimen under identical conditions. Gloss can be measured with a commercially available gloss meter.

“Turbidity” should be understood to be the percentage of reduction in transparency from transparent materials due to light scattering. The turbidity can be measured by a commercially available turbidity meter.

“Functional layer(s)” should be understood to be one or several layer(s) which is/are applied on the adhesion promoting layer, with or without an intermediate layer and which provide the glass with one or more properties so that the glass possesses the desired function(s).

The thinner a glass layer or plat is, the more difficult handling of the glass becomes. If the glass has a thickness≦2 mm, or ≦500 μm or even 300 μm, handling of glass becomes increasingly more difficult, mainly due to defects such as fine cracks and splintering on the edges of the glass, leading to a break. The entire mechanical strength, for example the bending or impact strength, is significantly reduced. Normally with thicker glass, the edge can be ground with CNC machines to remove defects; however, on thin or ultrathin glass with the aforementioned thicknesses, mechanical removal or grinding can no longer be feasibly performed. Etching at the corners or edges could be a solution for thin glass for the removal of defects. However, the flexibility of a thin glass plate or layer is still limited due to the low bending strength and prestressing or tempering for thin or ultrathin glass is therefore extremely important. Strengthening can be achieved through coating of the surface and the edges. This is, however, very expensive and not very effective. Surprisingly, it was noted that a glass, especially a glass containing alkali and aluminum, that was subjected to a specific chemical tempering process can obtain high mechanical strength as well as good flexibility and bendability.

After the ion exchange, a compressive stress layer is formed on the surface of the glass. However, the CS and DoL values which are normally recommended according to the art for thicker soda-lime or aluminosilicate glass, and which are normally used for chemically tempered glass, no longer apply to the thin glasses of the present invention. For a thin glass with a thickness<2 mm, the DoL and CT values are more critical than for a thicker glass; the glass would become damaged if these values are too high. Therefore, a DoL of less than 30 μm and a CT of less than 120 MPa can be threshold parameters for a chemically strengthened ultrathin glass.

The coated thin, chemically strengthened flexible glass of the present invention moreover shows that, when an adhesion promoting layer is present, a functional layer, which can be applied directly on the adhesion promoting layer, has a clearly higher long-term stability than without the adhesion promoting layer. Also, the properties of the functional layer can be improved by the adhesion promoting layer; this improvement is attributed to the fact that the adhesion promoting layer has a supportive and structural effect for additional functional layer(s) that is/are to be applied later.

The adhesion promoting layer can be a single layer, or can include or consist of one or several layers and, if required, can also have one or several intermediate layers. The adhesion promoting layer can be applied directly onto the glass, or one or several intermediate layers can be provided between the adhesion promoting layer and the glass. The adhesion promoting layer is or includes a silicon mixed oxide layer that includes or consists of a silicon oxide layer in combination with at least one oxide of aluminum, tin, magnesium, phosphorus, cerium, zirconium, titanium, caesium, barium, strontium, niobium, zinc, boron and/or magnesium, such as at least aluminum oxide or at least one aluminum oxide. In the case of a silicon-aluminum mixed oxide layer, the mol ratio of aluminum to silicon in the mixed oxide can be between approximately 3 and approximately 30%, such as between approximately 5 and approximately 20% or between approximately 7 and approximately 12%.

In the context of the present invention, silicon oxide should be understood as any silicon oxide SiOₓ, wherein x can assume any particular values in the range of 1 to 2. Silicon mixed oxide should be understood to be a mixture consisting of silicon oxide and an additional oxide of at least one other element which can be homogeneous or non-homogeneous, stoichiometric or non-stoichiometric.

The adhesion promoting layer itself can be a functional layer or may represent part of one or several functional layers. Depending on the function of the adhesion promoting layer, its thickness is selected according to the present invention. If the adhesion promoting layer does not serve an additional function, but acts only to promote adhesion, then the layer thickness can be 1 nm or greater, such as 10 nm or greater or 20 nm or greater. The adhesion promoting layer can be selected such that it represents, for example, an optically effective layer at the same time. An optically effective adhesion promoting layer may have a refractive index, for example, in the range of 1.35 to 1.7, such as in the range of 1.35 to 1.6 or in the range of 1.35 to 1.56 (at 588 nm reference wavelength).

The adhesion promoting layer can also consist of several layers between which one or several intermediate layers are inserted. The intermediate layer(s) can then have a thickness of 0.3 to 10 nm, such as a thickness of 1 to 3 nm. This helps primarily to avoid stress inside the adhesion promoting layer. The intermediate layers can, for example, consist of silicon oxide.

The adhesion promoting layer according to the present invention can be applied with any desired method for applying homogenous layers over a large surface. For example, a Sol-Gel method can be used, or a method using chemical of physical vapor deposition, such as sputtering.

Activation of the glass surface before application of the adhesion promoting layer can result in an additional improvement in the adhesion property of the applied layer. Treatment can occur by a wash process, or also as activation through Corona-discharge, flame treatment, UV-treatment, plasma activation and/or mechanical methods such as roughening, sandblasting and/or chemical processes such as etching or leaching.

The thin glass can be chemically strengthened before or after coating with the adhesion promoting layer and, if required, with at least one functional layer. The thin glass can also still be chemically strengthened and thereby chemically tempered after coating, without the coating suffering noticeable damage.

Glasses formed according to the present invention can be alkali- and boron-containing silicate glasses to satisfy the demands for strengthening or thin glass with low CS and low DoL and relatively long tempering time especially well. The thermal shock resistance of the raw glass plate or layer before chemical strengthening and the rigidity of the glass can also be relevant. To meet the desired specifications, the glass compositions should be selected accordingly.

In one exemplary embodiment, the glass has the following composition (in weight-%):

| Composition | (weight-%) |
|---|---|
| SiO₂ | 10-90 |
| Al₂O₃ | 0-40 |
| B₂O₃ | 0-80 |
| Na₂O | 1-30 |
| K₂O | 0-30 |
| CoO | 0-20 |
| NiO | 0-20 |
| Ni₂O₃ | 0-20 |
| MnO | 0-20 |
| CaO | 0-40 |
| BaO | 0-60 |
| ZnO | 0-40 |
| ZrO₂ | 0-10 |
| MnO₂ | 0-10 |
| CeO | 0-3 |
| SnO₂ | 0-2 |
| Sb₂O₃ | 0-2 |
| TiO₂ | 0-40 |
| P₂O₅ | 0-70 |
| MgO | 0-40 |
| SrO | 0-60 |
| Li₂O | 0-30 |
| Li₂O + Na₂O + K₂O | 1-30 |
| Nd₂O₅ | 0-20 |
| V₂O₅ | 0-50 |
| Bi₂O₃ | 0-50 |
| SO₃ | 0-50 |
| SnO | 0-70 |
| Whereby the content | is 10-90; |
| SiO₂ + B₂O₃ + P₂O₅ | |

In another exemplary embodiment, the thin glass is a lithium-aluminosilicate glass with the following composition (in weight-%):

| Composition | (weight-%) |
|---|---|
| SiO₂ | 55-69 |
| Al₂O₃ | 18-25 |
| Li₂O | 3-5 |
| Na₂O + K₂O | 0-30 |
| MgO + CaO + SrO + BaO | 0-5 |
| ZnO | 0-4 |
| TiO₂ | 0-5 |
| ZrO₂ | 0-5 |
| TiO₂ + ZrO₂ + SnO₂ | 2-6 |
| P₂O₅ | 0-8 |
| F | 0-1 |
| B₂O₃ | 0-2 |

A lithium-aluminosilicate glass of the present invention can have the following composition (in weight-%):

| Composition | (weight-%) |
|---|---|
| SiO₂ | 57-66 |
| Al₂O₃ | 18-23 |
| Li₂O | 3-5 |
| Na₂O + K₂O | 3-25 |
| MgO + CaO + SrO + BaO | 1-4 |
| ZnO | 0-4 |
| TiO₂ | 0-4 |
| ZrO₂ | 0-5 |
| TiO₂ + ZrO₂ + SnO₂ | 2-6 |
| P₂O₅ | 0-7 |
| F | 0-1 |
| B₂O₃ | 0-2 |

A lithium-aluminosilicate glass of the invention can also have the following composition (in weigh-%):

| Composition | (weight.-%) |
|---|---|
| SiO₂ | 57-63 |
| Al₂O₃ | 18-22 |
| Li₂O | 3.5-5 |
| Na₂O + K₂O | 5-20 |
| MgO + CaO + SrO + BaO | 0-5 |
| ZnO | 0-3 |
| TiO₂ | 0-3 |
| ZrO₂ | 0-5 |
| TiO₂ + ZrO₂ + SnO₂ | 2-5 |
| P₂O₅ | 0-5 |
| F | 0-1 |
| B₂O₃ | 0-2 |

In one exemplary embodiment, the thin flexible glass is a soda-lime glass with the following composition and includes (in weight-%):

| Composition | (weight-%) |
|---|---|
| SiO₂ | 40-81 |
| Al₂O₃ | 0-6 |
| B₂O₃ | 0-5 |
| Li₂O + Na₂O + K₂O | 5-30 |
| MgO + CaO + SrO + BaO + ZnO | 5-30 |
| TiO₂ + ZrO₂ | 0-7 |
| P₂O₅ | 0-2 |

The soda-lime glass of the present invention can have the following composition (in weight-%):

| Composition | (weight-%) |
|---|---|
| SiO₂ | 50-81 |
| Al₂O₃ | 0-5 |
| B₂O₃ | 0-5 |
| Li₂O + Na₂O + K₂O | 5-28 |
| MgO + CaO + SrO + BaO + ZnO | 5-25 |
| TiO₂ + ZrO₂ | 0-6 |
| P₂O₅ | 0-2 |

The soda-lime glass of the present invention can also have the following composition (in weight-%):

| Composition | (weight-%) |
|---|---|
| SiO₂ | 55-76 |
| Al₂O₃ | 0-5 |
| B₂O₃ | 0-5 |
| Li₂O + Na₂O + K₂O | 5-25 |
| MgO + CaO + SrO + BaO + ZnO | 5-20 |
| TiO₂ + ZrO₂ | 0-5 |
| P₂O₅ | 0-2 |

In one exemplary embodiment, the thin flexible glass is a borosilicate glass with the following composition (in weight-%):

| Composition | (weight-%) |
|---|---|
| SiO₂ | 60-85 |
| Al₂O₃ | 0-10 |
| B₂O₃ | 5-20 |
| Li₂O + Na₂O + K₂O | 2-16 |
| MgO + CaO + SrO + BaO + ZnO | 0-15 |
| TiO₂ + ZrO₂ | 0-5 |
| P₂O₅ | 0-2 |

The borosilicate glass of the present invention can have the following composition (in weight-%):

| Composition | (weight-%) |
|---|---|
| SiO₂ | 63-84 |
| Al₂O₃ | 0-8 |
| B₂O₃ | 5-18 |
| Li₂O + Na₂O + K₂O | 3-14 |
| MgO + CaO + SrO + BaO + ZnO | 0-12 |
| TiO₂ + ZrO₂ | 0-4 |
| P₂O₅ | 0-2 |

The borosilicate glass of the present invention can also have the following composition (in weight-%):

| Composition | (weight-%) |
|---|---|
| SiO₂ | 63-83 |
| Al₂O₃ | 0-7 |
| B₂O₃ | 5-18 |
| Li₂O + Na₂O + K₂O | 4-14 |
| MgO + CaO + SrO + BaO + ZnO | 0-10 |
| TiO₂ + ZrO₂ | 0-3 |
| P₂O₅ | 0-2 |

In one exemplary embodiment, the thin flexile glass is an alkali-aluminosilicate with the following composition (in weight-%):

| Composition | (weight-%) |
|---|---|
| SiO₂ | 40-75 |
| Al₂O₃ | 10-30 |
| B₂O₃ | 0-20 |
| Li₂O + Na₂O + K₂O | 4-30 |
| MgO + CaO + SrO + BaO + ZnO | 0-15 |
| TiO₂ + ZrO₂ | 0-15 |
| P₂O₅ | 0-10 |

The alkali-aluminosilicate glass of the present invention can have the following composition (in weight-%):

| Composition | (weight-%) |
|---|---|
| SiO₂ | 50-70 |
| Al₂O₃ | 10-27 |
| B₂O₃ | 0-18 |
| Li₂O + Na₂O + K₂O | 5-28 |
| MgO + CaO + SrO + BaO + ZnO | 0-13 |
| TiO₂ + ZrO₂ | 0-13 |
| P₂O₅ | 0-9 |

The alkali-aluminosilicate glass of the present invention can also have the following composition (in weight-%):

| Composition | (weight-%) |
|---|---|
| SiO₂ | 55-68 |
| Al₂O₃ | 10-27 |
| B₂O₃ | 0-15 |
| Li₂O + Na₂O + K₂O | 4-27 |
| MgO + CaO + SrO + BaO + ZnO | 0-12 |
| TiO₂ + ZrO₂ | 0-10 |
| P₂O₅ | 0-8 |

In one exemplary embodiment, the thin flexible glass is an aluminosilicate glass with low alkali content and the following composition (in weight-%):

| Composition | (weight-%) |
|---|---|
| SiO₂ | 50-75 |
| Al₂O₃ | 7-25 |
| B₂O₃ | 0-20 |
| Li₂O + Na₂O + K₂O | 1-4 |
| MgO + CaO + SrO + BaO + ZnO | 5-25 |
| TiO₂ + ZrO₂ | 0-10 |
| P₂O₅ | 0-5 |

The aluminosilicate glass with the low alkali content of the present invention can have the following composition (in weight-%):

| Composition | (weight-%) |
|---|---|
| SiO₂ | 52-73 |
| Al₂O₃ | 7-23 |
| B₂O₃ | 0-18 |
| Li₂O + Na₂O + K₂O | 1-4 |
| MgO + CaO + SrO + BaO + ZnO | 5-23 |
| TiO₂ + ZrO₂ | 0-10 |
| P₂O₅ | 0-5 |

The aluminosilicate glass with the low alkali content of the present invention can also have the following composition (in weight-%):

| Composition | (weight-%) |
|---|---|
| SiO₂ | 53-71 |
| Al₂O₃ | 7-22 |
| B₂O₃ | 0-18 |
| Li₂O + Na₂O + K₂O | 1-4 |
| MgO + CaO + SrO + BaO + ZnO | 5-22 |
| TiO₂ + ZrO₂ | 0-8 |
| P₂O₅ | 0-5 |

The above stated compositions respectively, can contain: if required, coloring oxides, such as Nd₂O₃, Fe₂O₃, CoO, NiO, V₂O₅, MnO₂, TiO₂, CuO, CeO₂, Cr₂O₃; 0-2 weight-% As₂O₃, Sb₂O₃, SnO₂, SO₃, Cl, F and/or CeO₂ as refining agent; and 0-5 weight-% rare earth oxides can also be added to introduce magnetic, photons or optic functions into the glass layer or plate. The entire volume of the total composition is always 100 weigh-%.

Table 1 illustrates several exemplary embodiments of thin alkali-containing glasses that can be chemically strengthened and coated with the adhesion promoting layer.

TABLE 1
Examples of alkali-containing borosilicate glasses

| Composition | Exam- | Exam- | Exam- | Exam- | Exam- | Exam- | Exam- | Exam- |
|---|---|---|---|---|---|---|---|---|
| (weight-%) | ple 1 | ple 2 | ple 3 | ple 4 | ple 5 | ple 6 | ple 7 | ple 8 |
| SiO₂ | 80 | 64 | 70 | 61 | 68 | 70 | 67 | 60 |
| Al₂O₃ | 3 | 7 | 1 | 18 | 9 | 8 | 6 | 7 |
| LiO | 0 | 0 | 0 | 5 | 0 | 0 | 0 | 0 |
| Na₂O | 5 | 6 | 8 | 10 | 5 | 3 | 5 | 8 |
| K₂O | 0 | 6 | 8 | 1 | 2 | 6 | 4 | 5 |
| CaO | 0 | 0 | 7 | 1 | 2 | 0 | 0 | 0 |
| BaO | 0 | 0 | 2.5 | 0 | 2 | 0 | 0 | 0 |
| ZnO | 0 | 5 | 2.4 | 0 | 0 | 1 | 2 | 0 |
| ZrO₂ | 0 | 0 | 0 | 3 | 3 | 0 | 0 | 0 |
| B₂O₃ | 12 | 8 | 0.1 | 1 | 8 | 12 | 16 | 20 |
| TiO₂ | 0 | 4 | 1 | 0 | 0 | 0 | 0 | 0 |

SiO₂, B₂O₃ and P₂O₅ act as glass network creators. For conventional methods, the total content should not be less than 40 weight-%, or the glass plate or layer cannot be formed and would become fragile and brittle and would lose transparency. A higher SiO₂ content requires a higher melting and processing temperature during glass production and thus this content should normally be less than 90 weight-%. The addition of B₂O₃ and P₂O₅ to SiO₂ can modify the network characteristics and lower the melting and processing temperature of the glass. The glass network creators moreover have a strong effect on the CTE of the glass.

Furthermore, the B₂O₃ in the glass network can form two different polyhedrons that can be better adapted to outside load force. The addition of B₂O₃ results normally in a low thermal shock resistance and slower chemical strengthening, whereby the low CS and small DoL can be readily maintained. The addition of B₂O₃ to thin glass can therefore greatly improve chemical strengthening, as a result of which the chemically strengthened thin glass can be widely used in practical applications.

Al₂O₃ acts as a glass network creator and also as a glass network modifier. The [AlO₄] tetrahedron and the [AlO₆] hexahedron are formed in the glass network, depending on the amounts of Al₂O₃. These can adjust the ion exchange pace by changing the space for the ion exchange within the glass network. If the Al₂O₃ volumes are too high, for example higher than 40 weight-%, the melting temperature and processing temperature of the glass becomes much higher and will tend to crystallize, which results in the glass losing transparency and flexibility.

The other oxides, such as K₂O, Na₂O and Li₂O, act as glass processing modifiers and can destroy the glass network through forming of non-bridging oxides within the glass network. The addition of alkali metals can reduce the processing temperature of glass and can increase the CTE of the glass. The presence of Na and Li is necessary for thin glass, so that it can be mechanically strengthened. The ion exchange of Na⁺/Li⁺, Na⁺/K⁺ and Li⁺/K⁺ is a necessary step for the strengthening process. The glass is not being strengthened if it does not in itself contain alkali metals. However, the total amount of alkali metals should not be more than 30 weight-%, or the glass network will be completely destroyed without forming the glass. One important factor is that the thin glass should have a low CTE, so that it is useful if the glass does not have an excess amount of alkali metals in order to meet this requirement.

Earth alkali oxides such as MgO, CaO, SrO and BaO, act as network modifiers and are able to reduce the formation temperature of the glass. These elements can change the CTE and Young's modulus of the glass, and the earth alkali elements also have an important function in changing the refractive index of the glass in order meet special requirements. For example, MgO can reduce the refractive index of the glass, whereas BaO can increase the refractive index. The amount of earth alkali elements should not be higher than 40 weight-% in glass production.

The transitional metal elements in the glass, such as ZnO and ZrO₂, have a similar function as those of the earth alkali elements. Other transitional metal elements, such as Nd₂O₃, Fe₂O₃, CoO, NiO, V₂O₅, MnO₂, TiO₂, CuO, CeO₂ and Cr₂O₃ can function as chromophoric compounds so that the glass possesses special photons or optical functions, for example a color filtering function or light conversion.

A thin glass that contains alkali metal ions can typically be produced through reducing a thicker glass through a removal or grinding process or etching. The two processes are easily performed, but are not economical. The surface quality—for example the Rₐ roughness and waviness—is hereby not good. The redrawing method can also be used, to form the thinner glass from a thicker glass, however the costs for this are also high and an efficient mass production is not easily realized.

Other production methods for thin alkali containing borosilicate glass plates or layers include the downdraw, overflow fusion and special float methods. The downdraw and overflow fusion methods are useful for mass production, wherein even production of an ultrathin glass with a thickness of 10 to 300 μm at a high surface quality is possible. In the downdraw or overflow fusion method, a natural or fire-polished surface with a roughness Rₐ of 5 nm or less, such as 2 nm or less or 1 nm or less can be produced. For the practical use in electronic devices, the glass plate or layer can have a thickness variation tolerance of ±10% or less. The thickness can still be accurately controlled in the range of ≦2 mm, but also in the range of 10 to 300 μm. It is the thin strength of the glass that provides flexibility to the glass. With a float process, a thin glass can be produced economically and in a suitable manner also for mass production. However, glass produced in the float process has one side—the tin side—that differs from the other side. The difference between the two sides, however, results in that a curvature occurs after chemical strengthening of the glass, so that subsequent coating is no longer possible since the two sides may display different surface energies. In the production of a thin glass by a float process, it is therefore useful to remove the tin side before further processing.

The thin glass can be produced and processed in the form of layers or plates or rolls. The layer size can 10×10 mm² or larger, such as 50×50 mm², 100×100 mm² or larger, 400×320 mm² or larger, 470×370 mm² or larger, or 550×440 mm² or larger. The thin glass roll can have a width of 200 mm or greater, such as 300 mm or greater, 400 mm or greater or 1 m or greater. The length of the glass roll can be longer than 1 m, such as longer than 10 m, longer than 100 m or longer than 500 m.

According to the present invention, chemical strengthening can be performed before or after coating with the adhesion promoting layer in the embodiment of a silicon mixed oxide layer.

The strengthening can be performed by dipping the glass plates or layers or glass rolls into a salt bath containing monovalent ions so that these are exchanged with alkali ions inside the glass. The monovalent ions in the salt bath have a diameter that is larger than that of the alkali ions inside the glass, due to which a compressive stress can be produced that acts upon the glass network after the ion exchange. After the ion exchange, the strength and the flexibility of the glass are increased. In addition, the compressive stress (CS) that is obtained through chemical strengthening, increases the scratch resistance of the glass, so that the hardened glass is not easily scratched; the DoL can also increase the scratch resistance, so that it is less probable that the glass breaks or is scratched.

The typical salt used for chemical strengthening is Nat-containing molten salt or K⁺-containing molten salt or mixtures thereof. Conventionally used salts include NaNO₃, KNO₃, NaCl, KCl, K₂SO₄, Na₂SO₄ and Na₂CO₃; additives, such as NaOH, KOH and other sodium salts or potassium salts or cesium salts are also used in order to better control the rate of the ion exchange for chemical strengthening. Ag⁺-containing or Cu²⁺-containing salt baths can be used to additionally provide antimicrobial properties to the glass.

The ion exchange can be performed online in a roll-to-roll process or in a roll-to-layer process.

Since the glass is very thin, the ion exchange should not be performed too quickly or too deeply, and the central tensile stress (CT) of glass is critical for very thin glass and can be expressed by the following equation:

$${σ}_{CT} = \frac{{σ}_{CS} \times {L}_{DoL}}{t - 2 \times {L}_{DoL}}$$

wherein σ_{CS} represents the value for CS, L_{DoL} is the thickness of the DoL, t is the thickness of the glass. The measurement for the tension is MPa and for the thickness μm. The ion exchange should not be performed to the same thickness as for a thicker glass and should not be performed too quickly, in order to provide precise control of chemical strengthening. Too great a DoL would induce a high CT and self-breakage of thin glass, or would even cause the disappearance of the CS if the thin glass is completely ion-exchanged, without the effect of hardening or strengthening occurring. A large DoL typically does not increase strength and flexibility of thin glass through chemical strengthening.

According to the present invention, the thickness of the glass t for ultrathin glass has a special correlation for DoL, CS and CT and is as follows:

$$\frac{0 , 9 t}{{L}_{DoL}} \geq \frac{{σ}_{CS}}{{σ}_{CT}}$$

According to one exemplary embodiment, the following correlation can be given:

$$\frac{0 , 2 t}{{L}_{DoL}} \leq \frac{{σ}_{CS}}{{σ}_{CT}}$$

Table 2 provides exemplary technical specifications for chemical strengthening, wherein CS and DoL values were controlled within specific ranges to achieve optimum strength and flexibility. The samples are chemically strengthened in a pure KNO₃ salt bath at a temperature of between 350 and 480° C. for 15 minutes to 48 hours, to obtain controlled CS and DoL values.

TABLE 2
Technical specifications for strengthening

| | | | |
|---|---|---|---|
| Thickness | DoL (μm) | CS (MPa) | CT (MPa) |

| | | | | |
|---|---|---|---|---|
| 0.3 | mm | <30 | <700 | <120 |
| 0.2 | mm | <20 | <700 | <120 |
| 0.1 | mm | <15 | <600 | <120 |
| 70 | μm | <15 | <400 | <120 |
| 50 | μm | <10 | <350 | <120 |
| 25 | μm | <5 | <300 | <120 |
| 10 | μm | <3 | <300 | <120 |

In one exemplary embodiment, a borosilicate glass has the properties of a relatively low CTE, low specific Young's modulus and a high temperature change stability. In addition to these properties, the borosilicate glass contains alkali and can also be chemically strengthened. Due to the relatively slow exchange process, the CS- and DoL values can herein be easily controlled.

An adhesive promoting layer is disposed on the chemically strengthened thin or ultrathin glass. One or several functional bendable or flexible coatings can be applied on the adhesion promoting layer of the thin glass. Through the application of one or several functional layers on the adhesion promoting layer of the glass, accordingly related applications can be accessed.

One possible functional layer that can be applied onto the adhesion promoting layer is an easy-to-clean coating. An easy-to-clean coating is a coating that has high dirt-repelling characteristics, is easily cleanable and also has an anti-graffiti effect. The material surface of such an easy-to-clean coating has resistance against deposits of, for example finger print marks such as liquids, salts, fats, dirt and other materials. This relates to the chemical resistance against such deposits, as well as to a low wetting behavior against such deposits. It also relates to suppression, avoidance or reduction in the appearance of fingerprint marks through touching by the user. In this case, an easy-to-clean layer becomes an anti-fingerprint coating. Fingerprints contain mainly salts, amino acids and fats, substances such as talcum, sweat, residues of dead skin cells, cosmetics and lotions and possibly dirt in the form of liquid or particles of different types. Such an easy-to-clean coating must therefore be resistant to water, salt and fat deposits which occur, for example, from residues of fingerprints during use. The wetting characteristic of a surface with an easy-to-clean coating must be such that the surface is hydrophobic, i.e., the contact angle between surface and water is greater than 90°, as well as oleophobic, i.e., the contact angle between the surface and oil is greater than 50°.

Easy-to-clean coatings are widely available on the market. These are, for example, fluoro-organic compounds as described, for example, in DE 19848591, EP 0 844 265, US 2010/0279068, US 2010/0285272 and US 2009/0197048, the disclosures of which are incorporated herein by reference. Known easy-to-clean coatings are produced on the basis of perfluoropolyether “Fluorolink® PFPE”, such as “Fluorolink® S10” by Solvay Solexis or also “Optool™ DSX” or “Optool™ AES4-E” by Daikin Industries LTD, “Hymocer® EKG 6000N” by ETC Products GmbH or fluorine silane under the trade name “FSD”, such as “FSD 2500” or “FSD 4500” by Cytonix LLC or Easy Clean Coating “ECC”-products, such as “ECC 3000” or “ECC 4000”, by 3M Deutschland GmbH. These are liquid-applied layers. Anti-fingerprint coatings, for example in the form of nanolayer systems that are applied by physical vapor deposition are offered, for example by Cotec GmbH under the trade name “DURALON Ultra Tec”.

An additional alternative of a functional layer that can be applied onto an adhesion promoting layer, is an electrically conductive coating for various applications—for example in capacitively functioning touch screens. Through the application of conducting coatings onto the strengthened thin glass plates or layers, flexible electric circuitry or sensors can be obtained. Inorganic and organic coatings can herein be applied onto thin glasses. However, inorganic conductive coatings, for example ITO, which are used conventionally in modern electronic devices have the disadvantage that they are not bendable. After repeated bending, the electric resistance is increased, because small cracks are produced during deformation of the substrates and the coating thereupon. Therefore, a thin glass with a thickness of ≦2 mm should be coated with non-ITO coatings, such as silver nanowires, carbon nanotubes, graphene, poly(3,4-ethylenedioxythiophene)/poly(styrene-sulfonate) (PEDOT/PSS), polyacetylene, polyphenylenevinylene, poly-pyrrole, polythiophene, polyaniline and polyphenylene-sulfide. The thickness of the conductive coating can be between 0.0001 μm and 100 μm, such as between 0.1 and 10 μm or between 0.08 and 1 μm. The conductive polymer coating is transparent or translucent and is optionally colored. The methods that are used to apply the conductive coatings include a chemical vapor deposition process (CVD), dip coating, spin coating, ink jet, casting, screen printing, varnishing and spraying.

The bendable, conductive non-ITO coating can have a Young's modulus of 50 GPa or less in order to ensure that the composition material of glass, adhesion promoting layer and organic material does not become too rigid or hard. The composite thin glass can have an adjustable transmission of 0 to 90% and an electrical surface resistance of 300 Ω/sq. or less, such as 200 Ω/sq. or less or 159 Ω/sq. or less and can be used in flexible electronic devices, such as copper-indium-gallium-selenium solar cells (CIGS-solar cells) and OLED-displays.

An additional feature in the use of a conductive non-ITO coating is that the coating process is performed at a low temperature environment. As a rule, a physical vapor deposition method (PVD) is used for coating with ITO, wherein the glass substrate is heated to a temperature of up to 200° C. or even higher. The high temperature would, however, lower the CD of the thin glass layer or plate and impair the strength and reliability of the thin layer or plate. The non-ITO coating is applied, as a rule, at a temperature of less than 150° C. and the strength and flexibility of the thin glass layer or plate is thereby maintained.

Moreover, a scratch resistant coating can also be applied as a possible functional layer onto the adhesion promoting layer, such as, for example, a silicon nitride coating.

Additional exemplary functional layers that can be applied onto the adhesion promoting layer are antireflective layers. Within the scope of the present invention, these should be understood to be layers that—at least in a part of the visible, ultraviolet and/or infrared spectrum of electromagnetic waves—cause a reduction in the reflectivity on the surface of a carrier material that is coated with this layer. At least the transmitted component of the electromagnetic radiation is to be increased herewith.

Within the scope of the present invention, the meaning “antireflective layer” should be understood to be synonymous with the term “anti-mirroring layer”.

The layers of an antireflective coating or anti-mirroring coating as possible functional layers can have any desired design. Exemplary embodiments are alternating layers (layers positioned next to one another, having alternating properties) having medium, high and low refractive indexes, such as with three layers wherein the uppermost layer is a low refractive layer. Other exemplary embodiments are also alternating layers consisting of high refractive and low refractive layers, such as with four or six layers, wherein the uppermost layer is a low refractive layer. Additional exemplary embodiments are single layer anti-reflection systems or layer designs, where one or several layers are interrupted by one or several optically non-effective very thin intermediate layers.

In one exemplary embodiment, the antireflective or anti-mirror coating consists of alternating high and low refractive layers. The layer system has at least two, but also four, six and more layers. In the case of a two-layer system, there is, for example, a first high reflective layer T upon which a low refractive layer S is applied. High refractive layer T often includes titanium oxide TiO₂, but also niobium oxide Nb₂O₅, tantalum oxide Ta₂O₅, cerium oxide CeO₂, hafnium oxide

HfO₂, as well as mixtures thereof with titanium oxide or with others of the aforementioned oxides. Low refractive layer S can include a silicon mixed oxide, such as a silicon oxide mixed with an oxide of the element of aluminum, tin, magnesium, phosphorus, cerium, zirconium, titanium, cesium, barium, strontium, niobium, zinc, boron and/or magnesium, wherein at least one oxide of the aluminum element is included. The refractive indexes of such single layers—at a reference wavelength of 588 nm—are in the following region: high refractive layer T is at 1.7 to 2.3, such as 2.05 to 2.15 and the low refractive layer S is at 1.35 to 1.7, such as 1.38 to 1.6 1.38 to 1.58, or 1.38 to 1.56. In the selected example, the low refractive layer S can serve at the same time as an adhesion promoting layer; the adhesion promoting layer then also acts as a functional layer.

In an additional exemplary embodiment, the antireflective or anti-mirror coating consists of alternating medium-, high- and low refractive layers. The layer system has at least three or five and more layers. In the case of a three-layer system, such coating includes an anti-mirror coating for the visible spectral range. This is an interference filter consisting of three layers with the following structure of individual layers: carrier material/M/T/S, wherein M is a layer with medium refractive index, T is a layer with high refractive index and S is a layer with low refractive index. The medium refractive layer M can include a mixed oxide layer, consisting of silicon oxide and titanium oxide; however aluminum oxide is also used. High refractive layer T can include titanium oxide and the low refractive layer S can include a silicon mixed oxide, such as a silicon oxide mixed with one of the elements aluminum, tin, magnesium, phosphorus, cerium, zirconium, titanium, cesium, barium, strontium, niobium, zinc, boron and/or magnesium fluoride, wherein at least one oxide of the aluminum element is included. The refractive indexes of such single layers, at reference wavelength of 588 nm are within the following range: medium refractive layer M at 1.6 to 1.8, such as 1.65 to 1.75; high refractive layer T at 1.9 to 2.3, such as 2.05 to 2.15; and low refractive layer S at 1.38 to 1.56, such as 1.42 to 1.50. The thickness of such single layers can be for a medium refractive layer M 30 to 60 nm, such as 35 to 50 nm or 40 to 46 nm; for a high refractive layer T 90 to 125 nm, such as 100 to 115 nm or 105 to 111 nm; and for a low refractive layer S 70 to 105 nm such as 80 to 100 nm or 85 to 91 nm. In the previously described embodiment, the low refractive layer S can serve at the same time as an adhesion promoting layer; the adhesion promoting layer then acts also as a functional layer.

In an additional exemplary embodiment of the present invention where the functional coating consists of several individual layers with different refractive indexes, the individual layers of the antireflective or anti-mirror coating include UV and temperature stable inorganic materials and one or several materials or mixtures from the following group: titanium oxide, niobium oxide, tantalum oxide, cerium oxide, hafnium oxide, silicon oxide, magnesium fluoride, aluminum oxide, zircon oxide. Such a coating has an interference layer system with at least four individual layers.

In an additional exemplary embodiment, such a functional coating includes an interference layer system with at least five individual layers having the following layer structure: thin glass (carrier material)/M1/T1/M2/T2/S, wherein M1 and M2 each are a layer with medium refractive index, T1 and T2 are layers with high refractive index and S is a layer with low refractive index The medium refractive layer M can include a mixed oxide layer consisting of silicon oxide and titanium oxide, but aluminum oxide or zirconium oxide can also be used. The high refractive layer T can include, for example, titanium oxide, but also niobium oxide, tantalum oxide, cerium oxide, hafnium oxide and mixtures thereof with titanium oxide. The low refractive layer S can include, for example, a silicon mixed oxide, such as a silicon oxide mixed with an oxide of at least one of the elements: aluminum, tin, magnesium, phosphorus, cerium, zircon, titanium, cesium, barium, strontium, niobium, zinc, boron and/or magnesium fluoride, wherein at least one oxide of aluminum is present. At a reference wavelength of 588 nm, the reflective indexes of such individual layers can be: for medium refractive layers M1, M2 in the range of 1.6 to 1.8, for high refractive layers T1, T2 in the range of greater than or equal to 1.9, and for low refractive layer S in the range of less than or equal to 1.58. The thickness of such layers can be for layer M1 at 70 to 100 nm, for layer T1 at 30 to 70 nm, for layer M2 at 20 to 40 nm, for layer T2 at 30 to 50 nm and for layer S at 90 to 110 nm. In the described embodiment, low refractive layer S can serve as adhesion promoting layer at the same time; the adhesion promoting layer can then also act as a functional layer.

Such coatings, consisting of at least four individual layers, such as five individual layers, are described in EP 1 248 959 B1 “UV-reflecting interference layer system”, the disclosure of which is incorporated in its entirety herein by reference.

Antireflective coating layers can also be additional layer systems that, through combination of different M-, T- and S-layers, can realize antireflective systems that deviate from the previously described systems. Within the scope of the present invention, all reflection-reducing layer systems that achieve a reduction in the optical reflection, at least in the spectral ranges relative to the substrate material, are to be considered as possible functional layers on the adhesion promoting layer.

In one exemplary embodiment of the present invention, the antireflective coating on the adhesion promoting layer is composed of one single layer. The antireflective coating which, in this embodiment, consists of one layer is a low refractive layer that can, if required, be interrupted by very thin, optically almost non-effective intermediate layers. The thickness of such an intermediate layer can be, for example, 0.3 to 10 nm, such as 1 to 3 nm or 1.5 to 2.5 nm.

The antireflective layer can consist of a porous single layer antireflective coating, such as a magnesium-fluoride layer. The single layer antireflection coating can be a porous Sol-Gel layer. Especially good antireflective properties can be achieved especially with single layer antireflective layers, if the volume component of the pores is 10% to 60% of the total volume of the antireflective coating. Such a porous antireflective single layer coating can have a refractive index in the range of 1.2 to 1.38, such as 1.2 to 1.35, 1.2 to 1.30, 1.25 to 1.38, or 1.28 to 1.38 (at 588 nm reference wavelength). Among other factors, the refractive index depends on the porosity.

This embodiment of an antireflective coating which consists of one individual layer, can be used in applications where the thin glass has an accordingly higher refractive index so that the antireflective effect of the single layer can develop. The antireflective coating consists as a single layer that has a refractive index that can be consistent with the square root of the refractive index of the thin glass or its surface ±10%, ±5% or ±2%. The antireflective coating can alternatively also be covered with one or severally optical almost ineffective layers, such as cover layers.

Such optically effective coatings on high refractive carrier materials are suitable, for example, for better light extraction of LED applications, or for spectacles or other uses of optical glasses.

It can be useful if an antireflective layer, such as the uppermost layer facing the air, contains porous nanoparticles with a core size of approximately 2 nm to approximately 20 nm, such as about 5 nm to approximately 10 nm, or approximately 8 nm. Porous nanoparticles can include silicon oxide and aluminum oxide. If the mol ratio of aluminum to silicon in the mixed oxide of these ceramic nanoparticles is approximately 1:4.0 to approximately 1:20, or approximately 1:6.6, and if thus the silicon-aluminum mixed oxide includes a composition of (SiO₂)₁₋ₓ(Al₂O₃)_{x/2} with x=0.05 to 0.25, such as 0.15, the coating has an especially high mechanical and chemical resistance. With porous nanoparticles that have a core size of approximately 2 nm to approximately 20 nm, such as about 5 nm to approximately 10 nm or approximately 8 nm, the transmission and reflection properties of one layer or of one layer system deteriorate only slightly through scattering.

In the layer system consisting of several functional layers, one or several layers an also be separated from one another by several very thin intermediate layers that do not impair the intended function, or impair it only very slightly. These intermediate layers serve predominantly for stress prevention inside a layer. For example, one or several silicon-oxide intermediate layers may be present. The thickness of such an intermediate layer can be 0.3 to 10 nm, such as 1 to 3 nm or 1.5 to 2.5 nm.

An additional functional layer that can be applied onto the adhesion promoting layer according to one exemplary embodiment of the present invention is a cover layer which can consist of one or several layers. The cover layer does not necessarily have to be the uppermost layer in the layer structure; it may also be an intermediate layer. As an intermediate layer, it may be designed such that that an interaction is possible, through the cover layer between the layer directly below it and the layer directly above it. For example, there may be an adhesion promoting layer immediately underneath the cover layer, and a function layer immediately above the functional layer, such as an easy-to-clean layer, wherein the effect of the adhesion promoting layer through the cover layer is not negatively affected. This cover layer can, for example, also be designed to be supportive for an addition functional layer(s) that is/are to be applied later. Such a cover layer can be designed as a porous layer. Such cover layers are, for example, porous Sol-Gel layers or thin, partially permeable oxide layers, applied flame pyrolytically. Such a cover layer can be produced from silicon oxide, wherein the silicon oxide can also be a mixed silicon oxide, such as a silicon oxide mixed with an oxide of at least one of the elements: aluminum, tin, magnesium, phosphorus, cerium, zircon, titanium, cesium, barium, strontium, niobium, zinc, boron and/or magnesium fluoride. To produce such a cover layer, a coating applied through flame pyrolysis or another thermal coating method, for example cold gas spraying or sputtering, is suitable.

An adhesion promoting layer may also be provided on the adhesion promoting layer that acts antimicrobially. The glass itself can also be equipped to be antimicrobial, by subjecting it to an ion exchange in an Ag⁺-containing or Cu²⁺-containing salt bath. After the ion exchange, the concentration of Ag⁺ or Cu²⁺ on the surface can be 1 ppm, 100 ppm or higher, or 1000 ppm or higher. The inhibition rate against bacteria can be higher than 50%, such as higher than 80% or higher than 95%. The thin glass with the antimicrobial function can be used for medical equipment, such as computers or screens that are used in hospitals.

The functional layers can, in principle, be applied with any coating method with which homogeneous layers can be applied over a large surface area. Examples are physical or chemical vapor deposition, such as sputtering, flame pyrolysis or Sol-Gel methods. With the latter, the layer can be applied onto the surface through dipping, vapor coating, spraying, printing, application with a roll, in a wiping method, in a coating or roll process and/or doctor blade or by another suitable method.

Different functional layers can also be combined with one another if the functions do not affect each other negatively. For example, an antireflective coating can be combined with an antiglare coating. An antireflective coating can also be combined with an easy-to-clean coating that is applied over it. The flexible glass that already has one AG property can, for example, be provided in addition with antimicrobial properties; or a glass that is already equipped with an antimicrobial layer can be provided with an antireflective layer and/or a conductive layer. A multifunctional integration can thus be realized in or for the glass. The existing adhesion promoting layer that is composed of one or several layers and, if required, can also have one or more intermediate layers which serves to improve the long-term durability of the functional layer or layers that are applied on it, as a result of which their properties effectively take effect.

In addition to the various functions that are given to a thin glass, additional properties of the thin glass can play a role. Thermal stress caused by a temperature difference is responsible for the breaking of the glass during a temperature change. The thermal tension or stress induced by chemical methods can also reduce the glass strength, causing the glass to become more brittle and to lose its flexibility. The thin glass is, in addition, more sensitive than thick glass to thermal stress. Thermal shock resistance and thermal stress stability are consequently particularly relevant for each other, when thin glass layers or plates are used.

In one exemplary embodiment, chemical strengthening includes rapid heating and chilling, whereby thermal quenching is essential for this method. A salt bath for chemical strengthening is generally heated to a temperature that is higher than 250° C. or is even as high as 700° C. to enable the salt bath to melt. If thin glass is dipped into a salt bath, temperature gradients develop between the glass and the salt bath and the gradient develops inside an individual glass piece, even if only a part of the glass is dipped into the salt bath. If, on the other hand, the thin glass is taken out of the salt bath, it is generally subjected to a rapid quenching procedure. Due to the small thickness, the thin glass is more susceptible to breaking at the same temperature gradient. The temperature change methods result, therefore, in a small yield if thin glass is strengthened without special compilation of the composition. Even though preheating and subsequent cooling can reduce the temperature gradient, these methods are time consuming and energy intensive. A glass with maximum temperature gradient can resist the temperature change resistance even during the preheating and chilling processes. A high temperature change resistance for the thin glass can be used in order to simplify chemical strengthening and to improve the yield. In addition to chemical strengthening, a thermal tension or stress during subsequent processing, such as laser cutting or thermal cutting, can be implemented after chemical strengthening.

From the foregoing, it should be understood that the thermal shock resistance of the original glass before chemical strengthening can be an important factor for the flexible thin glass because the thermal shock resistance determines the economical availability of the strengthened glass with high quality. The composition of the original glass plate or layer also plays a role in glass production and should therefore be carefully considered for each glass type, as previously described.

The robustness of the material relative to a temperature change is identified by the temperature change parameter:

$$R = \frac{σ ( 1 - μ ) λ}{E α}$$

Wherein R is the thermal shock resistance; λ is the coefficient of the thermal conductivity; α is the CTE; σ is the strength of a material, E is the Young's modulus and μ is the Poisson's ratio.

A higher value for R represents higher resistance against failure during a temperature change. The thermal tension and stress resistance for the glass is accordingly determined by the maximum thermal stress ΔT from the following equation:

$$Δ T ∝ \frac{2 σ ( 1 - μ )}{E α}$$

A glass with a higher R would have a higher thermal stress and would therefore have greater resistance to a temperature change.

For practical application, R should be higher than 190 W/m², such as higher than 250 W/m² or higher than 300 W/m², and ΔT should be higher than 380° C., such as higher than 500° C. or higher than 600° C.

The CTE is also of significance for the above-mentioned thermal shock resistance of thin glass. Glass with a low CTE and a low Young's modulus has a higher thermal shock resistance and is less susceptible to a break caused by a temperature gradient, and also has the property that uneven distribution of thermal stresses in the chemical strengthening process and other high-temperature processes, such as coating or cutting, is reduced. The CTE should be less than 10×10⁻⁶/K, such as less than 8×10⁻⁶/K, less than 7×10⁻⁶/K, less than 6×10⁻⁶/K or less than 5×10⁻⁶/K.

The resistance to temperature difference (RTG) can be measured by the following test: first, 250×250 mm² glass samples are produced. The center region of the sample plates is heated to a defined temperature, whereby at the same time the edges are left at room temperature. The temperature difference between the hot center region of the plate and the cool edges of the plate represents the resistance of the glass to temperature difference, if a break occurs in less than 5% of the samples. For use of thin glass, the RTG-value should be greater than 50 K, such as greater than 100 K, greater than 150 K or greater than 200 K.

The procedure of testing the resistance to thermal shock (RTS) is performed as follows: first, 200×200 mm² glass samples are produced, the samples are then heated in an ambient air furnace, then 50 ml cold water (room temperature) is poured onto the center region of the sample plates. The resistance value relative to a temperature change is the difference of the temperature between the hot plate and the cold water (room temperature), wherein a break occurs in less than 5% of the samples. For use of thin glass, the RTS-value should be greater than 75 K, such as greater than 115 K, greater than 150 K or greater than 200 K.

R is a theoretically calculated value in order to evaluate the thermal shock resistance without having to perform a thermal shock experiment. However, the thermal shock resistance of glass is also influenced by other factors, for example by the thickness and the processing history of the sample. The RTS is an experimental result that measures the specific thermal shock resistance of glass for a predetermined condition. The properties of the glass material are considered in calculating R, wherein the RTS is connected with other factors in practical application. The RTS is proportional to R, if the other conditions for the glass are the same.

ΔT is also a theoretically calculated value, like R, in order to evaluate the thermal shock resistance of glass material without having to perform a thermal shock experiment. However, the resistance of glass relative to a temperature difference is also highly dependent on the specific conditions, such as the size of a glass sample, the thickness of a glass and the processing history of a glass. The RTG is an experimental result that measures the resistance of the glass relative to a temperature difference for predetermined conditions. The properties of the glass material are considered in calculating ΔT, wherein the RTG relates to other factors in practical application. The RTG is proportional to ΔT, but is not necessarily identical with same.

In one exemplary embodiment, the borosilicate glass with low CTE has a much higher yield (greater than 95%) in a chemical strengthening process, whereas due to the higher CTs, induced by a higher CS and DoL, all aluminosilicate glasses break. Table 3 illustrates the properties of the embodiments shown in Table 1.

TABLE 3
Properties of exemplary thin glasses according to the invention

| | Example 1 | | Example 2 | | Example 3 | | Example 4 | | Example 5 | | Example 6 | | Example 7 | | Example 8 | |
|---|---|---|---|---|---|---|---|---|---|---|---|---|---|---|---|---|
| E | 64 | GPa | 73 | GPa | 72 | GPa | 83 | GPa | 70 | GPa | 64 | GPa | 63 | GPa | 65 | GPa |
| T_{g} | 525□ | | 557□ | | 533□ | | 505□ | | — | | — | | — | | — | |
| CTE | 3.3 × 10⁻⁶/K | | 7.2 × 10⁻⁶/K | | 9.4 × 10⁻⁶/K | | 8.5 × 10⁻⁶/K | | 5.2 × 10⁻⁶/K | | 5.2 × 10⁻⁶/K | | 5.6 × 10⁻⁶/K | | 7.1 × 10⁻⁶/K | |
| Annealing | 560° | C. | 557° | C. | 541° | C. | 515° | C. | — | | — | | — | | — | |
| point | | | | | | | | | | | | | | | | |
| Thickness | 2.2 | g/cm³ | 2.5 | g/cm³ | 2.5 | g/cm³ | 2.5 | g/cm³ | 2.4 | g/cm³ | 2.3 | g/cm³ | 2.3 | g/cm³ | 2.3 | g/cm³ |
| λ | 1.2 | W/mK | 0.9 | W/mK | 1 | W/mK | 1 | W/mK | 1.1 | W/mK | 1.1 | W/mK | 1.1 | W/mK | 1.1 | W/mK |
| σ* | 86 | MPa | 143 | MPa | 220 | MPa | 207 | MPa | 162 | MPa | 117 | MPa | 177 | MPa | 166 | MPa |
| Cutting | Diamond | | Diamond | | Filament | | Chemical | | Diamond | | Diamond | | Diamond | | Diamond | |
| method | cutting | | tip | | cutting | | etching | | tip | | cutting | | tip | | tip | |
| | wheel | | | | | | | | | | wheel | | | | | |
| μ | 0.2 | | 0.2 | | 0.2 | | 0.2 | | 0.2 | | 0.2 | | 0.2 | | 0.2 | |
| R | 391 | W/m | 196 | W/m | 260 | W/m | 235 | W/m | 392 | W/m | 309 | W/m | 441 | W/m | 316 | W/m |

| | | | | | | | | |
|---|---|---|---|---|---|---|---|---|
| ΔT | 652□ | 435□ | 520□ | 469□ | 712□ | 563□ | 802□ | 576□ |
| ε** | 29.1 | 29.2 | 28.8 | 33.2 | 29.2 | 29.1 | 28.6 | 26 |

*This is the strength of glass before chemical strengthening; this is also influenced by the cutting method
**The entity of ε is GPa · cm³/g

The material strength also influences the thermal shock resistance because a break due to heat stress occurs only if the thermal stress exceeds the material strength. After appropriate thermal tempering with a controlled CT below 120 MPa, the strength of the glass can be increased and the thermal shock resistance can also be improved. Table 4 shows the values for examples of chemically strengthened glass according to Table 3.

TABLE 4
Properties of exemplary glasses after chemical strengthening

| | Example 1 | | Example 2 | | Example 3 | | Example 4 | | Example 5 | | Example 6 | | Example 7 | | Example 8 | |
|---|---|---|---|---|---|---|---|---|---|---|---|---|---|---|---|---|
| Conditions of | 430° | C. | 400° | C. | 430° | C. | 410° | C. | 390° | C. | 430° | C. | 400° | C. | 400° | C. |
| chemical | 15 | h | 3 | h | 2 | h | 1 | h | 4 | h | 4 | h | 3 | h | 3 | h |
| strengthening | | | | | | | | | | | | | | | | |
| CS | 122 | MPa | 304 | MPa | 504 | MPa | 503 | MPa | 473 | MPa | 209 | MPa | 355 | MPa | 477 | MPa |
| DoL | 14 | μm | 14 | μm | 8 | μm | 7 | μm | 15 | μm | 20 | μm | 11 | μm | 9 | μm |
| Salt bath | 100% KNO₃ | | 100 KNO₃ | | KNO₃ + | | 95% KNO₃ + | | 100% KNO₃ | | 100% KNO₃ | | 95% KNO₃ + | | 100% KNO₃ | |
| | | | | | 1000 ppm | | 5% NaNO₃ | | | | | | 5% NaNO₃ | | | |
| | | | | | AgNO₃ | | | | | | | | | | | |
| Size of sample | 100 × | | 50 × | | 50 × | | 200 × | | 50 × | | 150 × | | 200 × | | 250 × | |
| | 100 × | | 50 × | | 50 × | | 200 × | | 50 × | | 150 × | | 200 × | | 250 × | |
| | 0.2 mm³ | | 0.1 mm³ | | 0.15 mm³ | | 0.1 mm³ | | 0.1 mm³ | | 0.05 mm³ | | 0.2 mm³ | | 0.3 mm³ | |
| Cutting method | Diamond | | Diamond | | Filament | | Chemical | | Diamond | | Diamond | | Diamond | | Diamond | |
| before chemical | cutting | | tip | | cutting | | etching | | tip | | cutting | | tip | | tip | |
| strengthening | wheel | | | | | | | | | | wheel | | | | | |
| Yield of chemical | ≧95% | | ≧90% | | ≧85% | | ≧90% | | ≧90% | | ≧90% | | ≧90% | | ≧95% | |
| strengthening | | | | | | | | | | | | | | | | |
| σ* | 147 | MPa | 329 | MPa | 473 | MPa | 558 | MPa | 470 | MPa | 201 | MPa | 339 | MPa | 466 | MPa |
| R | 668 | W/m | 451 | W/m | 559 | W/m | 557 | W/m | 1136 | W/m | 531 | W/m | 846 | W/m | 889 | W/m |
| ΔT | 1113° | C. | 1002° | C. | 1118° | C. | 1116° | C. | 2066° | C. | 966° | C. | 1537° | C. | 1616° | C. |

*is the strength of the glass after chemical strengthening; this is also influenced by the cutting method.

The thin glass can also have a low specific Young's modulus to provide better flexibility. Therefore, the thin glass can have lower rigidity and better bendability, which is excellent especially for roll-to-roll processing and handling. The rigidity of glass is defined by a specific Young's modulus:

$$ɛ = \frac{E}{ρ}$$

wherein E represents the Young's modulus, and p is the density of the glass. Since the density of the glass does not change significantly with its composition, the specific Young's modulus can be less than 84 GPa, such as less than 73 GPa or less than 68 GPa to render the thin glass flexible enough for winding. The rigidity of glass ε can be less than 33.5 GPa·cm³/g, such as less than 29.2 GPa·cm³/g or less than 27.2 GPa·cm³/g.

The flexibility of the glass f is characterized by the bending radius if the glass is bendable and no break occurs (radius r) and is defined typically by equation:

f=1/Radius

The bending radius is measured as the inside curve in the bent position of a material. The bending radius is defined as the minimum radius of the arc of a circle in the bent position, where a glass reaches maximum deflection before snapping or destruction or breaking. A lower r means greater flexibility and bending of the glass. The bending radius is a parameter that is determined by the glass thickness, the Young's modulus and the strength. Chemically strengthened thin glass has low thickness, a low Young's modulus and high strength. All three factors contribute to a low bending radius and better flexibility. The hardened flexible glass of the invention can have a bending radius of 300 mm or less, such as 250 mm or less, 200 mm or less, 150 mm or less, 100 mm or less, or 50 mm or less.

One exemplary embodiment of the present invention provides a method to produce a coated, chemically strengthened flexible thin glass, including:
producing the thin glass, such as by removal of thicker glass, etching of thicker glass, downdraw method, overflow fusion, float or redrawing method;
chemical strengthening of the glass; and
before or after chemical strengthening, applying one or several adhesion promoting layers and, optionally, one or several functional layers onto the glass.

The method of producing thin glass, and also the strengthening method, have been previously described in detail. Therefore, coating of a thin glass with an adhesion promoting layer is further explained in detail. Such a method can include the following steps:

after the thin, possibly already chemically strengthened glass substrate is provided, the surface or surface regions that is/are to be coated can be cleaned first. Cleaning with fluids in connection with glass substrates is a common procedure. Various cleaning fluids can be utilized, such as demineralized water or aqueous systems, such as diluted brines (pH>9) and acids, detergent-solutions or non-aqueous solvents, for example alcohols or ketones.

In an additional exemplary embodiment of the present invention, the thin glass substrate can also be activated before coating. Such activation processes include oxidation, Corona-discharge, flame treatment, UV-treatment, plasma activation and/or mechanical methods such as roughening, sandblasting or also treatment of the substrate surface that is to be activated, with an acid and/or a brine.

The surface treatment can moreover serve to provide the glass with a function. For example, a flexible glass layer or plate can be provided with an anti-glare (AG) function for use in unfavorable conditions. The surface can be treated appropriately for this, for example with sandblasting or chemical etching. After chemical etching, the surface of the thin glass can have a roughness of between 50 and 300 nm to realize an optimum AG-effect, whereby the gloss at a reflection angle of 60° can be between 20 and 120, such as between 40 and 110 or between 50 and 100; the gloss at a reflection angle of 20° can be between 30 and 100, such as between 40 and 90 or between 50 and 80; the gloss at a reflection angle of 85° can be between 20 and 140, such as between 30 and 130 or between 40 and 120; and the turbidity of the AG surface can be between 3 and 18, such as between 5 and 15 or between 7 and 13.

Subsequently, an adhesion promoting layer is applied by a suitable application method, for example by physical or chemical vapor deposition, by flame pyrolysis or a Sol-Gel method. With the latter, the adhesion promoting layer can be applied to the surface through dipping, steam application, spraying, application with a roll, wiping method or coating or roll process and/or a doctor blade process or another suitable method.

In an exemplary Sol-Gel method, a reaction of organometallic starting material in a dissolved state is exploited to form the layers. Through a controlled hydrolysis and condensation reaction of the organometallic starting materials, a metal oxide network structure is created, i.e., a structure in which metal atoms relate to one another through oxygen atoms, simultaneously with elimination of the reactive products such as alcohol and water. The hydrolysis can be accelerated through the addition of catalysts.

In one exemplary embodiment, the thin glass substrate is pulled from the solution during Sol-Gel coating at a speed of approximately 200 mm/min. to approximately 900 mm/min., such as at approximately 300 mm/min., whereby the moisture content of the ambient air is between 4 g/m³ and approximately 12 g/m³, such as around approximately 8 g/m³.

If the Sol-Gel coating solution is to be used or stored over a longer period, it is useful to stabilize the solution through addition of one or several complexing agents. These complexing agents must be soluble in the dipping solution and should be compatible favorably with the solvent in the dipping solution. Organic solvents that at the same time possess complex-forming properties can be used, such as methyl-acetate, ethyl-acetate, acetylacetone, acetoacetic ester, methyl-ethyl-ketone acetone or suchlike compounds. These stabilizers can be added to the solution in volumes of 1 to 1.5 ml/l.

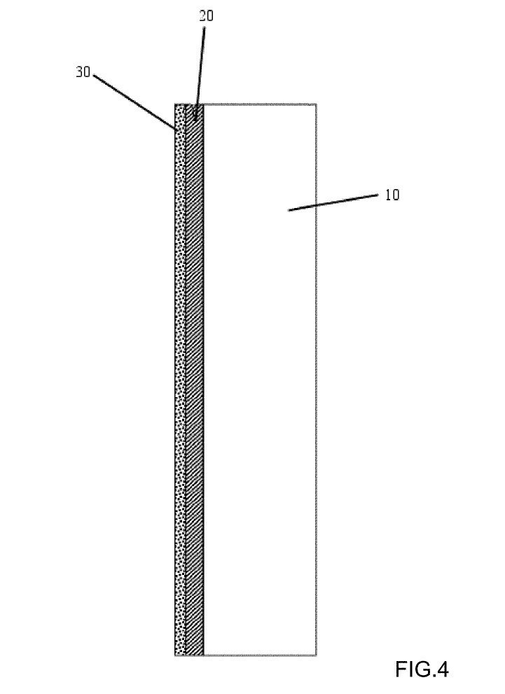

In one exemplary embodiment, for example according to FIG. 4, an adhesion promoting layer 20 is applied according to the Sol-Gel principle in order to produce a glass substrate. To produce a mixed silicon-oxide layer as adhesion promoting layer 20 on the at least one surface of the prepared, washed thin glass 10, said glass is dipped into an organic solution that includes a hydrolysable compound of the silicon. The glass is then pulled uniformly from this solution into a moisture-containing atmosphere. The layer thickness of the developing mixed silicon-oxide-adhesion promoting precursor layer is determined through the concentration of the silicon starting compound in the dipping solution and by the pull speed. After application, the layer can be dried, to achieve greater mechanical strength during transfer into the high temperature furnace. This drying can occur in a wide temperature range. At temperatures in the range of 200° C., drying times of a few minutes are typically required. Lower temperatures result in longer drying times. It is also possible to perform thermal strengthening in the high-temperature furnace immediately after application of the layer. The drying step herein aids the mechanical stabilization of the coating.

The development of the essentially oxidic adhesion promoting layer from the applied gel film occurs in the high temperature step, where organic components are burnt out from the gel. To produce the final mixed silicon oxide layer as the adhesion promoting layer, the adhesion promoting precursor layer is cured at temperatures below the softening temperature of the glass, for example at temperatures of less than 550° C. such as between 350 and 500° C. or between 400 and 500° C. substrate surface temperatures. Depending on the softening temperature of the base glass, temperatures of more than 550° C. can also be applied. However, these do not contribute to an additional increase in the adhesion strength.

The production of thin oxide layers from organic solutions has been well known for many years, as documented, for example, by H. Schroder “Physics of Thin Films, Academic Press New York and London (1967, pages 87-141) or in U.S. Pat. No. 4,568,578.

The inorganic Sol-Gel material from which the Sol-Gel layer is produced can be a condensate comprising one or several hydrolysable and condensable or condensed silane and/or metal-alkoxides, such as of Si, Ti, Zr, Al, Nb, Hf and/or Ge. In the Sol-Gel method, the groups that are cross-linked through inorganic hydrolysis and/or condensation can be the following functional groups: TiR₄, ZrR₄, SiR₄, AIR₃, TiR₃(OR), TiR₂(OR)₂, ZrR₂(OR)₂, ZrR₃(OR), SiR₃(OR), SiR₂(OR)₂, TiR(OR)₃, ZrR(OR)₃, AIR₂(OR), AIR(OR)₂, Ti(OR)₄, Zr(OR)₄, Al(OR)₃, Si(OR)₄, SiR(OR)₃ and/or Si₂(OR)₆ and/or one of the following residues or groups with OR: alkoxyl, such as methoxy, ethoxy, n-propoxy, isopropoxy, butoxy, isopropoxyethoxy, methoxypropoxy, phenoxy, acetoxy, propionyloxy, ethanolamine, diethanolamine, triethanolamine, methacryloxypropyl, acrylate, methylacrylate, acetylacetone, ethylacetoacetate, ethoxy acetate, methoxy acetate, methoxy ethoxy acetate and/or methoxy-ethoxy-ethoxy acetate, and/or one of the following remainders or groups with R::Cl, Br, F, methyl, ethyl, phenyl, n-propyl, butyl, allyl, vinyl, glycidylpropyl, methacryloyloxypropyl, aminopropyl and/or fluoroctyl.

All Sol-Gel reactions have in common is that the molecular dispersed precursors initially react through hydrolysis-, condensation- and polymerization reactions to particular-dispersed or colloidal systems. Depending on the selected conditions, the “primary particles” that are initially formed can grow further, combine to form clusters, or can form linear chains. The resulting units lead to micro-structures that are formed due to the removal of the solvent. In an ideal situation, the material can be thermally completely compressed. In reality, however, a degree of porosity often remains—in some cases even a substantial residual porosity. The chemical conditions during the Sol production have therefore a critical influence upon the properties of the Sol-Gel coating, as described in P. Löbmann, “Sol-Gel Coatings”, Advanced Training Course 2003, Surface Processing of Glass”—Hüttentechnische Vereinigung der deutschen Glasindustrie (Research Association of the German Glass Industry).

Si starting materials have been closely examined to date. In this regard, reference is made to C. Brinker, G. Scherer, “Sol-Gel-Science—The Physics and Chemistry of Sol-Gel Processing” (Academic Press, Boston 1990), R. Iller, The Chemistry of Silica (Wiley, New York, 1979). The Si starting materials that are used most often are silicon alkoxides of the formula Si(OR)₄ that hydrolyze when water is added. Under acidic conditions, linear aggregates can be formed. Under alkaline conditions, the silicon alkoxides react to form more highly cross-linked “globular” particles. The Sol-Gel coatings contain pre-condensed particles and clusters.

Normally, silicic acid tetra-ethyl-ester or silicic acid tetra-methyl-ester is used to produce a silicon-oxide dipping solution as a starting compound. This is mixed in the following stated sequence with an organic solvent, for example ethanol, hydrolysis water and acid as catalyzer and stirred thoroughly. Added to this can be hydrolysis water mineral acids, for example HNO₃, HCl, H₂SO₄, or organic acids such as acetic acid, ethoxy acetic acid, methoxy acetic acid, polyether carbon acids (for example ethoxy-ethoxy acetic acid) citric acid, p-toluene sulfonic acid, lactic acid, methacrylic acid or acrylic acid.

In one exemplary embodiment, the hydrolysis is performed completely or partially alkaline, for example by use of NH₄OH and/or tetramethylammonium-hydroxide and/or NaOH.

To produce the adhesion promoting layer, the dipping solution can be produced as follows: the silicon starting compounds for the mixed silicon-oxide layer are dissolved in one or several organic solvents. Any organic solvents can be used that dissolve the silicon starting compounds and that can moreover dissolve a sufficient volume of water that is necessary for the hydrolysis of the silicon starting compound. Suitable solvents are, for example, toluene, cyclohexane or acetone C1 to C6 alcohols such as methanol, propanol, butanol, pentanol, hexanol or isomers thereof. It is useful to use lower alcohols, such as methanol and ethanol, since these are easy to handle and have a relatively low vapor pressure.

The utilized silicon starting compound for the silicon oxide can be a silicic acid Cl to C4 alkyl ester; that is a silicic acid methyl ester, -ethyl ester, -propyl ester or -butyl ester.

The concentration of the silicon starting compound in the organic solvent is normally around 0.05 to 1 mol/liter. For the hydrolysis of the silicon starting compound, this solution is mixed in the described example with 0.05 to 12 weight-% water, which can be distilled water, and with 0.01 to 7 weight-% of an acid catalyst. Hereto organic acids, such as acetic acid, methoxy-acetic acid, polyether carbon acids (for example ethoxy-ethoxy acetic acid), citric acid, para-toluene sulfonic acid, lactic acid, methacrylic acid or acrylic acid or mineral acids such as HNO₃, HCl or H₂SO₄ can be added.

The pH value of the solution can be approximately 0.5 and ≦3. If the solution is not sufficiently acidic (pH>3), there is a danger that the poly-condensate/clusters become too large. If the solution is too acidic, there is risk that the solution gels.

In an additional exemplary embodiment, the solution can be produced in two steps. The first step occurs as described above. This solution is then left to mature. The maturing time is achieved in that the matured solution is diluted with additional solvents and/or maturing is interrupted by moving the pH-value of the solution into the strongly acid range, such as into a pH-range of 1.5 to 2.5. Moving the pH-value into the strongly acid range can be achieved through addition of an inorganic acid, such as through addition of hydrochloric acid, nitric acid, sulfuric acid or phosphoric acid or any organic acid such as oxalic acid or the like. The strong acid can be added into the solvent in which the silicon starting compound is already present in a dissolved state. It is also possible to add the acid in a sufficient volume together with the solvent, such as in an alcoholic solution so that the dilution of the starting solution and the interruption of the maturing process occur in one step.

In one exemplary embodiment, the hydrolysis is performed completely or partially in alkaline media, for example by using NH₄OH and/or tetramethylammonium-hydroxide and/or NaOH.

The Sol-Gel coatings comprise pre-condensed particles and clusters that can have different structures. These structures can be determined through implementation of scattered light experiments. By the process parameters such as temperature, rate of addition, stirring speed, or by the pH-value, it is possible that these structures are produced in the solutions. It has been shown that the use of smaller silicon oxide-poly-condensates/clusters with a diameter of less than or equal to 20 nm, such as less than or equal to 4 nm or in the range of 1 to 2 nm facilitates the production of immersion-layers that are packed more densely than conventional silicon oxide layers. This leads, for example, to an improvement of the chemical resistance of the layer.

To produce a mixed silicon oxide layer, an additive is added to the silicon starting compound. This additive provides an improvement of the chemical resistance and the function of the adhesion promoting layer. The solution is hereby mixed with small amounts of an additive that distributes itself homogenously in the solution and later also in the layer, forming a mixed oxide. Suitable additives are hydrolysable or dissociating inorganic salts, possibly containing crystallization water, selected from the salts of tin, aluminum, phosphorus, boron, cerium, zircon, titanium, cesium, barium, strontium, niobium and/or magnesium, for example SnCl₄, SnCl₂, AlCl₃, Al(NO₃)₃, Mg(NO₃)₂, MgCl₂, MgSO₄, TiCl₄, ZrCl₄, CeCl₃, Ce(NO₃)₃ and the like. These inorganic salts can be used in aqueous form or also with crystallization water. They are generally useful because of their low cost.

In an additional exemplary embodiment, the additive or additives can be selected from one or several metal oxides of tin, aluminum, phosphorus, boron, cerium, zircon, titanium, cesium, barium, strontium, niobium and/or magnesium.

Also suitable are phosphoric acid esters, such as phosphoric acid methyl ester or -ethyl ester, phosphoric halides such as chlorides and bromide, boric acid ester such as ethyl-, methyl-, butyl or propyl ester, boric acid anhydride, BBr₃, BCI₃, magnesium methylate or -ethylate and the like.

This one or several additive(s) are added, for example, in a concentration of approximately 0.5 to 20 weight-%, calculated as oxide, based on the silicon content in the solution, calculated as SiO₂. The additives can also be used in any desired combination.

If the dipping solution is to be used or stored over a longer period, it can be useful if the solution is stabilized through the addition of one or more complexing agents. These complexing agents should be solvable in the dipping solution and be consistent with the solvent of the dipping solution.

Complexing agents that can be used include, for example, ethyl acetoacetate, 2,4-pentanedion (acetyl acetone), 3,5-heptandion, 4,6-nonandion, 3-methyl-2,4-pentanedion, 2-acetylacetone, triethanolamine, diethynolamine, ethanolamine, 1,3-propandiol, 1,5-pentanediol, carbonic acids, such as acetic acid, propionic acid, ethoxy acetic acid, methoxy acetic acid, polyether-carbonic acids (i.e. ethoxyethoxy acetic acid), citric acid, lactic acid, methyl-acrylic acid and acrylic acid and the like.

The molar ratio of complexing agents to metalloid oxide precursors and/or metal oxide precursors is hereby in the range of 0.1 to 5.

In addition to chemical strengthening, the coating applied onto the glass and the properties of the glass itself, processing of the thin glass can also play a role in the strength and flexibility.

Possible treatment methods for the thin flexible glass include mechanical cutting with diamond tips or cutting wheels, or alloy cutting wheels, thermal cutting, laser cutting or water jet cutting. Structuring processes, such as ultrasonic drilling, sandblasting and chemical etching on the edge or surface can also be used to produce textures on the glass layer or plate.

Laser cutting includes conventional and non-conventional laser cutting. Conventional laser cutting is realized by a continuous wave laser (CW), such as a CO₂ laser or a conventional green laser, conventional infrared lasers, conventional UV lasers. Rapid heating through a laser, followed by rapid quenching generally results in a glass break and separation. Direct heating by a laser to evaporate materials is also possible with high-energy lasers, but at very low cutting rates. Both methods lead to undesirable micro-tears and rough surface finish. The materials that are cut with conventional laser methods require post-processing for removal of the unwanted edges and surface damages. On thin glass, the edge is difficult to work with and, therefore, a conventional laser cutting process is normally followed by chemical etching for finishing.

Non-conventional laser cutting is based on filaments of ultrashort pulsed lasers, whereby ultrashort laser pulses are used in the nano- or pico- or femto- or atto-second range, that cut brittle materials via plasma-dissociation, induced by filamentation or self-focusing of the pulse laser. This non-conventional method ensures higher quality cutting edges, lower surface roughness, higher bendability and faster processing. This new laser cutting technology works especially well on chemically strengthened glass and other transparent materials which are difficult to cut with conventional methods.

Despite the now available non-conventional laser cutting method, the separation of the glass substrate into several smaller individual plates is still problematic with strengthened glasses and, in many cases, not possible with most of the separation methods. Therefore, in practice the substrate is usually separated into individual entities with chemically strengthened glasses. The individual plates of the substrate are then strengthened and subjected to further processing steps. This method is, however, more elaborate.

Another exemplary embodiment of the present invention provides a method to produce a coated, chemically strengthened, flexible thin glass, including:
producing the thin glass, such as by removal of thicker glass, etching of thicker glass, downdraw method, overflow fusion, float or redrawing method, and
before or after chemical strengthening, applying an adhesion promoting layer and, optionally, one or several functional layers onto the glass, and
if required, separating the glass into smaller entities, whereby the separation is performed as follows:
before chemical strengthening, at least one relief is worked into at least one side of the glass, and, after chemical strengthening, the glass is separated along the at least one relief into smaller entities;
or
the chemically strengthened glass is heated along at least one line to a temperature of above the glass transition temperature T_{g}, such as above the upper annealing temperature, and is subsequently separated along the line into smaller entities.

So that a separation into individual entities can be performed also after chemical strengthening, a relief in the form of an indentation is initially worked along an intended separation line into at least one side of the substrate. The incorporation of the at least one relief is possible by any known process methods, for example mechanically, such as by grinding or scoring, thermally, such as by laser ablation, or chemically through an etching process. The borrow can hereby be provided so that a desired edge geometry is achieved after the separation, for example a cross section such as a V- or U-shape or rectangular shape. Rounded edges or substrates with C-shaped edges can be produced, whereby the substrate has an arched contour along the edge. Also possible are chamfered edges, such as a rounded or angular chamfer.

After incorporation of the at least one relief, the components of the substrate that are to be separated are still attached to one another through a remaining web. Two reliefs, opposite each other on both sides of the substrate, may also be incorporated, so that a step to the web exists on both sides.

After working in the at least one relief, the substrate is chemically strengthened, whereby the lines along which the substrate is to be separated are already incorporated in the form of reliefs. The substrate is then separated along the at least one relief. This is possible since the remaining web is substantially thinner so that it receives a clearly reduced strengthening and the lateral stresses are also reduced.

Separation of the substrate into individual pieces occurs therefore only after strengthening, so that additional processing steps can be performed before separation of the substrate.

According to one exemplary embodiment, the following procedure may therefore be followed:
producing at least one relief in at least one surface of a thin glass substrate;
chemical strengthening of the thin glass substrate;
coating of the thin glass substrate with an adhesion promoting layer and, if required, with at least one functional layer; and
separating the thin glass substrate.

According to another exemplary embodiment, the following procedure may be followed:
coating of the thin glass substrate with an adhesion promoting layer and, if required, with at least one functional layer;
chemical strengthening of the thin glass substrate; and
separating the thin glass substrate.

According to this exemplary embodiment, chemical strengthening extends also to the already preformed edges and around same.

A web remaining after incorporation of the relief can have half the thickness, a quarter of the thickness, or a maximum of an eight of the thickness of the substrate. The remaining web can have a thickness of between 10 μm and 500 μm, such as between 20 and 300 μm or between 50 and 150 μm. After the production of the relief, the remaining web can have a maximum thickness of four times, such as a maximum of three times or a maximum of double, the thickness of a layer produced through the strengthening process.

Alternatively, separation of the glass substrate, that is separation of the substrate into several pieces, can be performed after chemical strengthening in that a chemically strengthened glass substrate is heated along at least one line to a temperature above the glass transition temperature T_{g}, such as above the upper annealing temperature. The upper annealing temperature is herein to be understood to be the temperature at which the glass has a viscosity of 10¹³ dPas and at which the glass rapidly relaxes. The glass substrate is then separated along this line.

Through local heating, the prestress produced by the chemical strengthening process can be removed locally in such a way that it is possible to perform a separation by conventional, such as tension-induced, separation processes, for example by mechanical scribing or separation by laser scribing.

According to an additional exemplary embodiment, the following procedure may be followed:
coating of the thin glass substrate with an adhesion promoting layer and, if required, with at least one functional layer;
chemical strengthening of the thin glass substrate;
heating along at least one line to a temperature above the glass transition temperature T_{g} on at least one surface of the thin glass substrate; and
separating the thin glass substrate into individual entities.

According to another exemplary embodiment, the following procedure may be followed:
chemical strengthening of the thin glass substrate;
coating of the thin glass substrate with an adhesion promoting layer and, if required, with at least one functional layer;
heating along at least one line to a temperature above the glass transition temperature T_{g} on at least one surface of the thin glass substrate; and
separating the thin glass substrate into individual entities.

The heating does not have to be uniform in each case along a continuous line. It can also occur over parts of the line along which the separation is to occur, or on several points, etc.

To provide sufficient time for the substrate material to relax, the glass substrate can be heated along the later separation line for a time of at least 0.5 seconds, such as at least one second, to a temperature above the glass transition temperature. Local heating can be performed on one or on both sides.

Separation into individual entities can be performed also after chemical strengthening of a thin glass substrate.

Another exemplary embodiment of the present invention also provides an article, including the coated chemically strengthened flexible thin glass, wherein the thin glass layer or plate has a thickness of 2 mm or less, such as 1.2 mm or less, 500 μm or less, 400 μm or less, or 300 μm or less.

Exemplary embodiments of the present invention also provide the use of the coated, chemically strengthened flexible thin glass, for example for monitors, such as computer monitors, tablet computers or tablets, TVs, display panels such as large screen displays, navigation devices, mobile telephones, PDA or handheld computers, notebooks or display instruments for motor vehicles or aircraft, as well as glazing of all types, wherein the coated chemically strengthened flexible thin glass can be used as follows:

as protection, for example, for resistive touchscreens, for displays, mobile telephones, laptops, TVs, mirrors, windows, aircraft mirrors, furniture and household appliances, to avoid disturbing or contrast-reducing reflections;

as cover, for example as cover for solar-modules;

as display panels for monitors or display viewing pane, such as a 3D-display or flexible display;

as a pane in the interior and exterior architectural field, such as shop windows, glazing of pictures, show cases, refrigeration units or with problematic accessibility for cleaning, for range viewing pane;

as decorative glass element, such as in stresses areas with higher contamination risk, such as kitchens, bathrooms or laboratories;

as substrate for interactive input elements, such as touch function with resistive, capacitive, optical, and by infrared or surface acoustic wave effective touch-technology, such as a single, dual or multi-touch display; and/or

as substrate in a composite element where reflection on one or several interface surfaces with air spaces inside the composite element are avoided through optically adapted compounds.

It should be appreciated that the present invention is not limited to the exemplary embodiments described previously, but can be varied in a diverse manner. Other embodiments are possible.

Exemplary embodiments of the present invention are described below with reference to tests and examples which, however, are not to limit the scope of the present invention.

### EXAMPLES

### Examination of the Strength of Chemically Strengthened Thin Glass

### Test 1

The glass with the composition of example 1 in Table 1 is melted at 1600° C., is formed to a starting glass layer or plate of 440×360×0.2 mm³ by a downdraw method, and is then cut with a conventional abrasive cutting wheel with more than 200 diamond teeth. The samples are sized to 100×100×0.2 mm³. A total of 40 samples are produced. Then, 20 samples are chemically strengthened in 100% KNO₃ for 15 hours at 430° C. For reference purposes, the remaining 20 samples are not chemically prestressed. After the ion exchange, the strengthened samples are cleaned and measured with the FSM6000. The results show that the average CS is 122 MPa and the DoL is 14 μm.

The strength of the glass is measured by a three-point bending test. In the test, the glass sample is placed horizontally on two parallel rigid metal rods and one metal rod is placed onto the glass to press the glass downward until it breaks. The results of three-point bending show that the glass has a high bending strength of 147 MPa and can reach a bending radius of 45 mm without breaking. The (bending) strength of the non-pre-strengthened samples is much lower, at approximately 86 MPa and the bending radius is almost 100 mm. The flexibility is strongly increased after chemical strengthening and it is less probable that the glass will break during handling.

Commercial soda-lime glasses that have the composition as shown in Table 5 were produced with the same thickness of 0.2 mm and the bending radius before chemical strengthening is approximately 160 mm. The soda-lime glass has a lower flexibility compared to example 1, because boron reduces the rigidity of the glass. Soda-lime glass also has a low resistance to thermal shock (R<159 W/m) and breakage occurs during chemical strengthening, so that the yield is generally lower than 50%. The yield of chemical strengthening of samples with the composition per example 1 in table 1 is above 95% due to the excellent resistance to thermal shock and resistance to temperature difference.

### Test 2

The glass with the composition per example 2 in Table 1 is melted, formed to a starting glass layer or plate of 440×360 mm and a thickness of 0.1 mm by a downdraw method, and is then cut with a conventional diamond tip. The samples are sized to 50×50 mm². A total of 120 samples are produced. Then, 100 samples are chemically strengthened in 100% KNO₃ under various conditions. For reference purposes, the remaining 20 samples are not chemically prestressed.

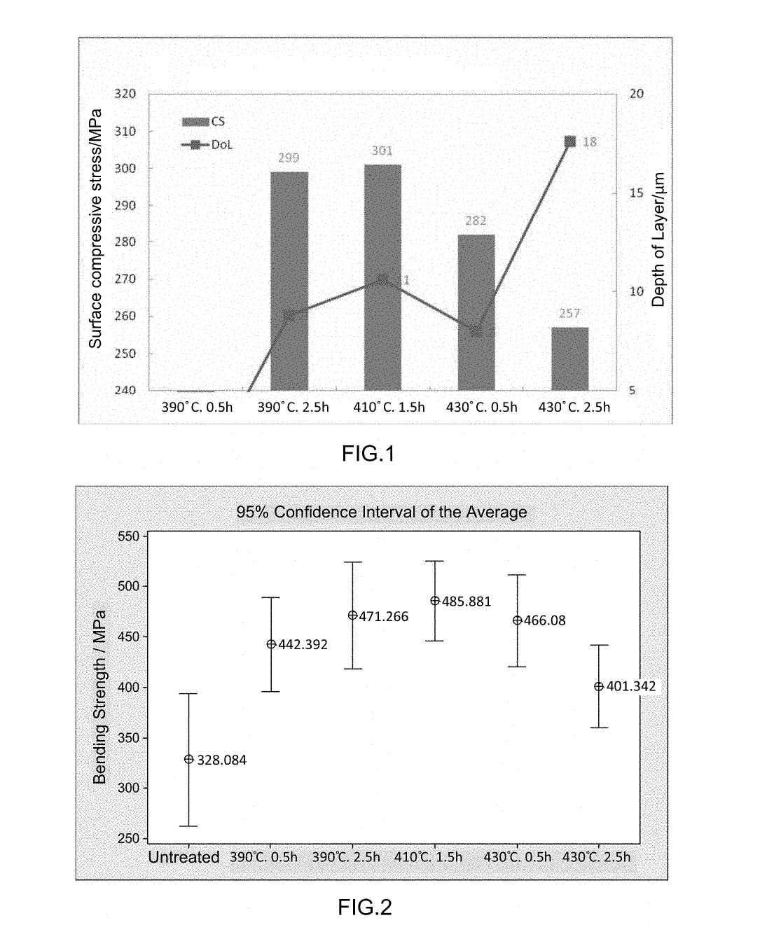

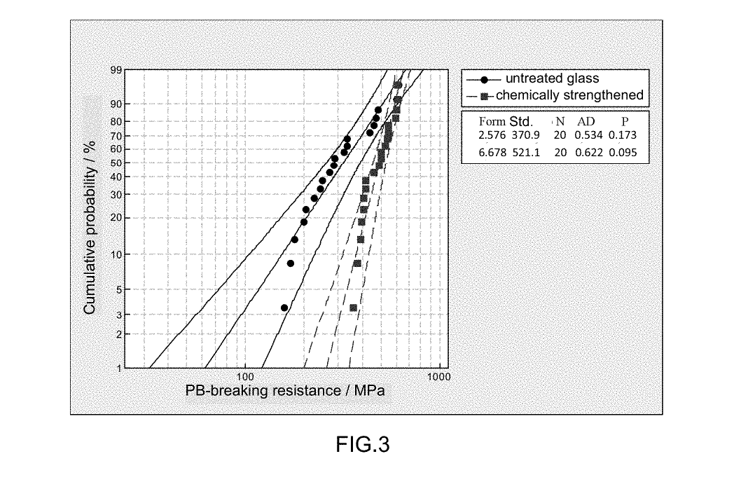

After strengthening, the ion-exchanged glass samples are washed and their CS and DoL values measured with the SFSM6000 device. The CS and DoL values are shown in FIG. 1. The mechanical strength of these samples is measured with the three-point bending test. As shown in FIG. 2, the chemically strengthened glass registers a flexibility increase. The chemically strengthened glass has a better Weibull-distribution, compared with non-strengthened samples, as shown in FIG. 3. The Weibull distribution illustrates the sample distribution of non-strengthened glasses. It was noted, that the distribution profiles progress more vertically, indicating that the sample distribution after the strengthening process is less and the quality is more uniform, substantiating the reliability of the glass in practice.

The commercial aluminosilicate glass sample that has the composition as shown in Table 5 is also produced for comparison. The thickness of 0.8 mm of the original starting glass is reduced to 0.1 mm by polishing and chemical etching and is cut to a size of 50×50 mm² in order to be used for chemical strengthening. All samples broke during the chemical strengthening process, because the CS and DoL values are so high (above 800 MPA, or greater than 30 μm) that based on the high CT (>600 MPa), self-breakage occurs. In fact, the high CT (>700 MPa) and the high DoL (>40 μm) for the cover glass that is used in mobile phones do not translate to strengthening of increase of flexibility for thin glass.

### Examination of the Resistance of Thin Glass to Temperature Differences

### Test 3

The glass with the composition according to example 8 in the table is melted, formed into a starting glass layer or plate of 440×360×0.3 mm³ by a down-draw method, is reduced by polishing and grinding and is then cut with a diamond cutter into a size of 250×250×0.3 mm³, in order to test the resistance to temperature differences. After chemical strengthening for 3 hours at 400° C., the center sections of the sample plates or layers were heated to a defined temperature and the edges or corners were held at room temperature. The temperature difference between the hot center of the plate or layer, and the cool plates or layer edges represents the resistance to a temperature difference of the glass if a break occurs in 5% or less of samples. The samples are recorded, whereby all have a resistance to a temperature difference of more than 200 K. Before testing, the samples are rubbed with sandpaper with a grit size of 40 in order to simulate an extreme damage that would be possible in practical use. This confirms in a suitable manner that the thin glass has very high reliability.

### Examination of the Resistance of Thin Glass to Thermal Shock

### Test 4

The glass with the composition according to example 7 in Table 1 is melted, formed into a starting glass layer or plate of 440×360×0.2 mm³ by a down-draw method and is then cut with a diamond cutter into a size of 200×200×0.3 mm³, in order to test for thermal shock resistance. The samples were chemically strengthened for 4 hours at 400° C. and were then heated in an ambient air furnace, after which 50 ml cold water (room temperature) is poured onto the center region of the sample plates. The value for the thermal shock resistance of the glass is the difference of the temperature between the hot plate and the cold water (room temperature), wherein a break occurs in less than 5% of the samples. The result shows that the samples show a thermal shock resistance of 150 K. Before heating, the samples are rubbed with sandpaper with a grit size of 220 to simulate the typical condition of the surface during practical use. This substantiates in a suitable manner that the thin glass has a very high reliability.

### Examination of the Strength of the Thin Glass, Subject to the Cutting Process

### Test 5

The glass with the composition according to example 2 in Table 1 is produced by a down-draw method in a size of 440×360×0.1 mm³. The first set of samples, consisting of 20 glass pieces is produced by a diamond cutting wheel to a size of 50×50×0.1 mm³; a second set of samples, consisting of 20 glass pieces is produced with a diamond tip to a size of 50×50×0.1 mm³′ and a third set of samples consisting of 20 glass pieces are produced by filament cutting with a picosecond laser to a size of 50×50×0.1 mm³.

Ten samples from each set are subjected to a three-point bending test. The samples that are cut with a diamond cutting wheel have an average strength of approximate 110 MPa, whereas the samples cut with a diamond tip have an average strength of approximately 140 MPa and the samples cut with a filament process have an average strength of approximately 230 MPa with best edge and corner quality.

The ten samples from each set were chemically strengthened in a 100% KNO₃ salt bath for 3 hours at 400° C. All samples are subjected to a treatment under almost identical values for CS (300 MPa) and DoL (18 μm) and then they were all tested with the three-point bending test. The strengthened samples, cut with a diamond cutting wheel had a strength of 300 MPa, the strengthened samples that were cut with a diamond tip had a strength of approximately 330 MPa, and the strengthened samples that were cut in a filament cutting process had a strength of approximately 400 MPa. The cutting process, therefore, has an influence upon the strength of the samples according to chemical strengthening.

TABLE 5
Properties of commercial glass for comparison

| Composition | Commercial | | Commercial | |
|---|---|---|---|---|
| (weight-%) | AS-glass | | soda-lime glass | |
| SiO₂ | 65.2 | | 70 | |
| Al₂O₃ | 16.8 | | 2 | |
| Li₂O | 0.01 | | — | |
| Na₂O | 14.4 | | 13 | |
| K₂O | 0.02 | | 1 | |
| MgO | 3.36 | | 4 | |
| CaO | 0.03 | | 10 | |
| SnO | 0.18 | | — | |
| E | 72 | GPa | 73 | GPa |
| CTE | 8.0 × 10⁻⁶/K | | 9.0 × 10⁻⁶/K | |
| Dichte | 2.5 | g/cm³ | 2.5 | g/cm³ |
| Λ | 1 | W/mK | 1 | W/mK |
| σ * | 127 | MPa | 131 | MPa |
| Cutting process | Diamond cutting wheel | | Diamond cutting wheel | |
| R | 176 | W/m | 159 | W/m |
| ΔT | 352° | C. | 319° | C. |

* is the strength of glass without chemical strengthening and is also influenced by the cutting process.

Examination of Long-Term Resistances of a Functional Coating of a Thin Glass Coated with an Adhesive Promoting Layer

### Glass Substrate 1: (Formed According to the Present Invention)

To produce a dipping solution, 60.5 ml silicic acid tetraethyl-ester, 30 ml distilled water and 11.5 g 1 N nitric acid were added to and stirred into 125 ml ethanol. After adding water and nitric acid the solution was stirred for 10 minutes, during which the temperature did not exceed 40° C. If necessary, the solution had to be cooled. The solution was subsequently diluted with 675 ml ethanol. After 24 hours, 10.9 g Al(NO₃)₃×9 H₂O, dissolved in 95 ml ethanol and 5 ml acetylacetone, were added to this solution. A carefully cleaned 10×20 cm borosilicate float glass plate with a thickness of 0.2 mm was dipped into the dipping solution. The plate was then removed from the solution at a speed of 6 mm/sec., whereby the moisture content in the ambient atmosphere was between 5 g/m³ and 12 g/m³, such as 8 g/m³. The solvent was then evaporated at 90 to 100° C. and the layer was then cured at a temperature of 450° C. for 20 minutes. The layer thickness of the thus produced adhesion promoting layer was approximately 90 nm.

### Glass Substrate 2 (Comparison Example):

A conventional silicon coating known from the art, i.e., a mixed silicon-oxide layer not formed according to the present invention, was applied according to the Sol-Gel method onto a thin glass as an adhesion promoting layer.

To produce the dipping solution, 125 ml ethanol was used. 45 ml silicic acid, 40 ml distilled water and 5 ml glacial acetic acid were added and stirred in. After the addition of water and acetic acid, the solution was stirred for 4 hours, whereby the temperature did not exceed 40° C. If necessary, the solution had to be cooled. The reaction solution was subsequently diluted with 790 ml ethanol and mixed with 1 ml HCl. A carefully cleaned 10×20 cm borosilicate float glass plate with a thickness of 0.2 mm was dipped into the dipping solution. The plate was then removed from the solution at a speed of 6 mm/sec., whereby the moisture content in the ambient atmosphere was between 5 g/m³ and 10 g/m³, such as 8 g/m³. The solvent was then evaporated at 90 to 100° C. and the layer was then cured at a temperature of 450° C. for 20 minutes. The layer thickness of the thus produced adhesion promoting layer was approximately 90 nm.

### Glass Substrate 3 (Comparison Example):

A borosilicate float glass plate without adhesion promoting layer was used.

Glass substrates 1, 2 and 3 described above respectively were coated with a functional layer. In the current examples, the four easy-to-clean coatings described below were selected as functional layers and respectively applied onto the glass substrates:

Easy-to-clean coatings that were used:
“Optool™ AES4-E” by Daikin Industries LTD., a perfluoroether with terminal silane residue.
“Fluorolink® S10” by Solvay Solexis, a perfluoroether with two terminal silane residues.
Self-produced coating formulations with the designation of “F5”: Dynasylan® F 8261 by Evonik was used as precursor. To produce the concentrate, 5 g Precursor Dynasylan® 8261, 10 g ethanol, 2.5 g H₂O and 0.24 g HCL are mixed and stirred for 2 minutes. 3.5 g concentrate were mixed with 500 ml ethanol for coating formulation F5.
“Duralon UltraTec” by Cotec GmbH, Frankenstraβe 19, 0-63791 Karlstein. With this coating, the substrate glasses are treated in a vacuum process. The substrate glasses that are coated with the respective adhesion promoting layer are put into a vacuum vessel that is subsequently evacuated to low vacuum. The “Duralon UltraTec” in the embodiment of a tablet (14 mm diameter, 5 mm high) is placed into an evaporator that is housed in a vacuum vessel. In this evaporator, the coating material is evaporated out of the filler material of the tablet at temperatures of 100° C. to 400° C. and deposits itself onto the surface of the adhesion promoting layer of the substrate. The time and temperature profiles are adjusted as specified by Cotec GmbH for evaporation of the tablet consisting of the “Duralon UltraTec” material. The substrates reach a slightly elevated temperature during the process, in the range between 300 K to 370 K.

Glass substrates 1 to 3 onto which one of the above referenced easy-to-clean coatings was respectively applied, are subjected to a neutral salt spray test according to DIN EN 1096-2:2001-05 (NSS-test).

### Neutral Salt Spray Test According to DIN EN 1096-2:2001-05 (NSS-Test)

In the neutral salt spray test, the coated glass samples are subjected to a neutral saltwater atmosphere for 21 days at a constant temperature. The saltwater spray mist causes the stress in the coating. The glass samples are placed in a specimen holder, so that the samples form an angle with the vertical of 15±5°. The neutral salt solution was produced by dissolving pure NaCl in deionized water, so that a concentration of (50±5) g/l at (25±2) ° C. was achieved. The salt solution was atomized via an appropriate nozzle in order to produce the salt spray mist. The operating temperature of the test chamber had to be 35±2° C.

Before the test and after 168 h, 336 h and 504 h test time, the contact angle to water was always measured to characterize the stability of the hydrophobic property. In a decline of the contact angle to below 60°, the test was always interrupted, since this correlates with a loss of the hydrophobic property.

### Contact Angle Measurement

Contact angle measurement was performed with the PCA100 device that enables determination of the contact angle with various liquids and the surface energy.

The measuring range applies for the contact angle of 10 to 150° and for the surface energy of 1×10⁻² to 2×10³ mN/m. Depending on the condition of the surfaces (cleanliness, uniformity of the surface) the contact angle can be precisely determined to 1°. The accuracy of the surface energy depends on how precisely the individual contact angles are located on a regression line calculated per Owens-Wendt-Kaelble, and is stated as regression value.

Samples of any size can be measured since this is a portable device that can be placed on large sheets to take measurements. The sample must be at least large enough that a drop can be placed on it, without getting into a conflict with the sample edge. The program can process various drop-methods. In this case, the Sessile droplet method is generally used and evaluated with the “ellipse fitting” (Ellipse method).

The sample surface is cleaned with ethanol before the measurement is taken. Then the sample is positioned, the measuring fluid dropped and the contact angle measured. The surface energy (polar and dispersible portion) is determined from a regression line that is adapted according to Owens-Wendth-Kaelble.

To get a measure for the long-term durability, a contact angle measurement is conducted after a long-lasting NSS-test. For the measurement results illustrated herein, deionized water was used as the measuring fluid. The error tolerance of the measured results is +4°.

### Test Results

The samples were examined before, during and after the neutral salt spray test (NSS-Test). Before and during the neutral salt spray test (NSS-Test), the water contact angles were determined on the samples. The results are stated in Tables 6 and 7.

TABLE 6
Neutral salt spray test (NSS-Test)

| | | Duration | | Color |
|---|---|---|---|---|
| Description | Coating | (h) | Atack | change |
| Glass | Optool ™ AES4-E | 504 h | No | Minimal |
| substrate 1 | | | | |
| Glass | Fluorolink ® S10 | 504 h | No | Minimal |
| substrate 1 | | | | |
| Glass | F5 | 504 h | No | Minimal |
| substrate 1 | | | | |
| Glass | Duralon Ultra | 504 h | No | Minimal |
| substrate 1 | Tec | | | |
| Glass | Optool ™ AES4-E | 168 h | Yes | Strong |
| substrate 2 | | | | |
| Glass | Fluorolink ® S10 | 168 h | Yes | Strong |
| substrate 2 | | | | |
| Glass | F5 | 168 h | Yes | Strong |
| substrate 2 | | | | |
| Glass | Duralon Ultra | 168 h | Yes | Strong |
| substrate 2 | Tec | | | |
| | | | Yes | Strong |
| Glass | Optool ™ AES4-E | 168 h | Yes | Strong |
| substrate 3 | | | | |
| Glass | Fluorolink ® S10 | 168 h | Yes | Strong |
| substrate 3 | | | | |
| Glass | F5 | 168 h | Yes | Strong |
| substrate 3 | | | | |
| Glass | Duralon Ultra | 168 h | Yes | Strong |
| substrate 3 | Tec | | | |

Glass substrate 1: with adhesion promoting layer formed according to the present invention;
Glass substrate 2: with silicon oxide layer formed according to the known art (comparison); and
Glass substrate 3: without adhesion promoting layer (comparison).

TABLE 7
Water contact angle measurements before and during the
neutral salt spray test (NSS-Test) as function of time

| | | Contact angle measurement [°] | | | |
|---|---|---|---|---|---|
| | | Before | after | After | after |
| Description | Coating | Test | 168 h | 336 h | 504 h |
| Glass | Optool ™ AES4-E | 102 | 95 | 93 | 90 |
| substrate 1 | | | | | |
| Glass | Fluorolink ® S10 | 102 | 100 | 97 | 98 |
| substrate 1 | | | | | |
| Glass | F5 | 103 | 89 | 81 | 79 |
| substrate 1 | | | | | |
| Glass | Duralon Ultra | 106 | 104 | 102 | 101 |
| substrate 1 | Tec | | | | |
| Glass | Optool ™ AES4-E | 100 | 58 | — | — |
| substrate 2 | | | | | |
| Glass | Fluorolink ® S10 | 103 | 56 | — | — |
| substrate 2 | | | | | |
| Glass | F5 | 103 | 59 | — | — |
| substrate 2 | | | | | |
| Glass | Duralon Ultra | 109 | 32 | — | — |
| substrate 2 | Tec | | | | |
| Glass | Optool ™ AES4-E | 104 | 67 | — | — |
| substrate 3 | | | | | |
| Glass | Fluorolink ® S10 | 105 | 63 | — | — |
| substrate 3 | | | | | |
| Glass | F5 | 101 | 51 | — | — |
| substrate 3 | | | | | |
| Glass | Duralon Ultra | 104 | 45 | — | — |
| substrate 3 | Tec | | | | |

Glass substrate 1: with adhesion promoting layer formed according to the present invention;
Glass substrate 2: with silicon oxide layer formed according to the known art (comparison); and
Glass substrate 3: without adhesion promoting layer (comparison).

The samples with the adhesion promoting layer formed according to the present invention as a base for an easy-to-clean (ETC) coating show no visible attack, with only slight color change even after a test period of 504 hrs. In contrast, a Sol-Gel silicon oxide coating according to the known art as a base for an easy-to-clean coating shows a strong attack after a 168-hour test period, with strong color change. The resistance of the coated thin glass formed according to the present invention in the NSS-test was more than 21 days, whereas glass substrates from the known art with another or no adhesion promoting layer were resistant for only a maximum of 7 days.

The adhesion promoting layer formed on a thin glass substrate according to the present invention as the basis for the different easy-to-clean coatings provides, in all observed cases, a significant improvement of the long-term stability. In comparison, an easy-to-clean coating on a substrate without adhesion promoting layer shows a loss of hydrophobic properties after 168 hours NSS-test. To maintain a high contact angle for practically relevant easy-to-clean properties, this should be above 80°. This was recognized as a good parameter, to determine maintenance of the properties after a stress test. The NSS test is a widely-recognized test of one of the critical tests for such coatings. It reflects stresses that occur, for example, due to fingerprint marks caused by touching. The salt content of the finger sweat is a typical influence for the layer failure. The long-term durability is herein considered a decisive property. The NSS-Test has hereby a significant relevance regarding the actual touch and outdoor-applications for example of touch panels and touch screens.

After application of an easy-to-clean coating onto an adhesion promoting layer formed according to the present invention, the water contact angle for the easy-to-clean coating—after being subjected to a more than three-times longer stress influence in the neutral salt spray test—is still higher than with the same easy-to-clean coating that is applied without an adhesion promoting layer, and with accordingly shorter stress influences in the neutral salt spray test. At a decrease of the water contact angle in the long-term NSS-test of up to 10%, the easy-to-clean layer was not substantially affected, at a decrease of the water contact angle to less than 50° it can be concluded that the easy-to-clean layer no longer exists, or exists in a greatly damaged state and has lost its effect. The measurement results in table 7 show, on all easy-to-clean coatings that are directly applied on a glass surface or on a silicon oxide coating according to the known art, an extensive to complete loss of the easy-to-clean or anti-fingerprint property after 7 days, whereas the same coatings on the adhesion promoting layer formed according to the present invention maintain their full effectiveness in part also after 21 days.

From the results, it was recognized that for all examined fluoro-organic compounds the glass substrate with an adhesion promoting layer formed according to the present invention ensures a clear extension of the resistance compared with a conventional glass substrate without adhesion promoting layer.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A coated, chemically strengthened flexible thin glass, comprising:
a coating applied to said glass and comprising an adhesion promoting layer in the form of a silicon mixed oxide layer which one of includes and consists of a silicon oxide layer in combination with at least one oxide of aluminum, tin, magnesium, phosphorus, cerium, zirconium, titanium, cesium, barium, strontium, niobium, zinc, boron and magnesium.

2. The glass according to claim 1, wherein said at least one oxide is an aluminum oxide.

3. The glass according to claim 1, wherein said glass has a thickness of 2 mm or less and includes an ion exchange layer with a depth DoL (L_{DoL}) of less than 30 μm and a central tensile stress CT (σ_{CT}) of 120 MPa.

4. The glass according to claim 1, wherein said glass has a thickness (t) of less than 300 μm and includes an ion exchange layer with a depth DoL (L_{DoL}) of less than 30 μm achieved through control of a slow ion exchange rate, a surface compressive stress CS (σ_{CS}) between 100 MPa and 700 MPa and a central tensile stress CT (σ_{CT}) of less than 120 MPa, wherein said thickness, said depth, said surface compressive stress, and said central tensile stress meet the following correlation:
$$\frac{0 , 9 t}{{L}_{DoL}} \geq \frac{{σ}_{CS}}{{σ}_{CT}} .$$

5. The glass according to claim 4, wherein said thickness, said depth, said surface compressive stress, and said central tensile stress meet the following correlation:
$$\frac{0 , 2 t}{{L}_{DoL}} \leq \frac{{σ}_{CS}}{{σ}_{CT}} .$$

6. The glass according to claim 1, wherein said chemical strengthening of said glass includes a slow ion exchange in a salt bath at a temperature of between 350 and 700° C. for a duration of 15 minutes to 48 hours.

7. The glass according to claim 1, further comprising a functional layer applied onto said adhesion promoting layer, said functional layer being applied one of directly to said adhesion promoting layer and to said adhesion promoting layer with at least one intermediate layer therebetween.

8. The glass according to claim 7, wherein said functional layer is at least one of an easy-to-clean layer, an anti-fingerprint layer, an optically active layer, an antireflective layer, an antiglare layer, an anti-scratch layer, a conductive layer, a cover layer, a protective layer, an abrasion resistant layer, and a colored layer.

9. The glass according to claim 1, wherein said adhesion promoting layer is a liquid-phase coating.

10. The glass according to claim 9, wherein said liquid-phase coating is one of a thermally cured Sol-Gel coating, a CVD-coating, a flame pyrolysis coating, and a PVD-coating.

11. The glass according to claim 1, wherein said adhesion promoting layer consists of one of:
a single layer;
a plurality of layers; and
a plurality of layers with at least one intermediate layer between two of said layers, said at least one intermediate layer having a thickness of 0.3 to 10 nm.

12. The glass according to claim 1, wherein said adhesion promoting layer one of:
is applied directly onto said glass; and
is applied onto at least one intermediate layer between said adhesion promoting layer and said glass.

13. The glass according to claim 1, wherein said adhesion promoting layer one of:
is an optically effective layer; and
is not optically effective and has a thickness of at least 1 nm.

14. The glass according to claim 1, wherein one of before and after chemical strengthening, said glass has at least one of the following characteristics:
a CTE of 10×10⁻⁶/K;
a thermal shock parameter R greater than 190 W/m;
a maximum thermal stress ΔT higher than 380° C.;
a resistance to temperature difference RTG of more than 50° K;
a resistance to thermal shock RTS of more than 75° K;
a Young's modulus of less than 84 GPa; and
a rigidity ε of less than 33.5 GPa·cm³/g.

15. The glass according to claim 1, wherein said glass has the following composition in weight-%:

| | |
|---|---|
| SiO₂ | 10-90; |
| Al₂O₃ | 0-40; |
| B₂O₃ | 0-80; |
| Na₂O | 1-30; |
| K₂O | 0-30; |
| CoO | 0-20; |
| NiO | 0-20; |
| Ni₂O₃ | 0-20; |
| MnO | 0-20; |
| CaO | 0-40; |
| BaO | 0-60; |
| ZnO | 0-40; |
| ZrO₂ | 0-10; |
| MnO₂ | 0-10; |
| CeO | 0-3; |
| SnO₂ | 0-2; |
| Sb₂O₃ | 0-2; |
| TiO₂ | 0-40; |
| P₂O₅ | 0-70; |
| MgO | 0-40; |
| SrO | 0-60; |
| Li₂O | 0-30; |
| Sum Li₂O + Na₂O + K₂O | 1-30; |
| Nd₂O₅ | 0-20; |
| V₂O₅ | 0-50; |
| Bi₂O₃ | 0-50; |
| SO₃ | 0-50; and |
| SnO | 0-70, |

wherein the content of SiO₂+B₂O₃+P₂O₅ is 10-90 weight-%.

16. The glass according to claim 1, wherein said glass is a lithium-aluminosilicate glass with the following composition in weight-%:

| | |
|---|---|
| SiO₂ | 55-69; |
| Al₂O₃ | 18-25; |
| Li₂O | 3-5; |
| Sum Na₂O + K₂O | 0-30; |
| Sum MgO + CaO + SrO + BaO | 0-5; |
| ZnO | 0-4; |
| TiO₂ | 0-5; |
| ZrO₂ | 0-5; |
| Sum TiO₂ + ZrO₂ + SnO₂ | 2-6; |
| P₂O₅ | 0-8; |
| F | 0-1; and |
| B₂O₃ | 0-2. |

17. The glass according to claim 16, wherein said lithium-aluminosilicate glass has the following composition in weight-%:

| | |
|---|---|
| SiO₂ | 57-66; |
| Al₂O₃ | 18-23; |
| Li₂O | 3-5; |
| Sum Na₂O + K₂O | 3-25; |
| Sum MgO + CaO + SrO + BaO | 1-4; |
| ZnO | 0-4; |
| TiO₂ | 0-4; |
| ZrO₂ | 0-5; |
| Sum TiO₂ + ZrO₂ + SnO₂ | 2-6; |
| P₂O₅ | 0-7; |
| F | 0-1; and |
| B₂O₃ | 0-2. |

18. The glass according to claim 16, wherein said lithium-aluminosilicate glass has the following composition in weight-%:

| | |
|---|---|
| SiO₂ | 57-63; |
| Al₂O₃ | 18-22; |
| Li₂O | 3.5-5; |
| Sum Na₂O + K₂O | 5-20; |
| Sum MgO + CaO + SrO + BaO | 0-5; |
| ZnO | 0-3; |
| TiO₂ | 0-3; |
| ZrO₂ | 0-5; |
| Sum TiO₂ + ZrO₂ + SnO₂ | 2-5; |
| P₂O₅ | 0-5; |
| F | 0-1; and |
| B₂O₃ | 0-2. |

19. The glass composition according to claim 1, wherein said glass is a soda-lime glass with the following composition in weight-%:

| | |
|---|---|
| SiO₂ | 40-81; |
| Al₂O₃ | 0-6; |
| B₂O₃ | 0-5; |
| Sum Li₂O + Na₂O + K₂O | 5-30; |
| Sum MgO + CaO + SrO + BaO + ZnO | 5-30; |
| Sum TiO₂ + ZrO₂ | 0-7; and |
| P₂O₅ | 0-2. |

20. The glass composition according to claim 19, wherein said soda-lime glass has the following composition in weight-%:

| | |
|---|---|
| SiO₂ | 50-81; |
| Al₂O₃ | 0-5; |
| B₂O₃ | 0-5; |
| Sum Li₂O + Na₂O + K₂O | 5-28; |
| Sum MgO + CaO + SrO + BaO + ZnO | 5-25; |
| Sum TiO₂ + ZrO₂ | 0-6; and |
| P₂O₅ | 0-2. |

21. The glass composition according to claim 20, wherein said soda-lime glass has the following composition in weight-%:

| | |
|---|---|
| SiO₂ | 55-76; |
| Al₂O₃ | 0-5; |
| B₂O₃ | 0-5; |
| Sum Li₂O + Na₂O + K₂O | 5-25; |
| Sum MgO + CaO + SrO + BaO + ZnO | 5-20; |
| Sum TiO₂ + ZrO₂ | 0-5; and |
| P₂O₅ | 0-2. |

22. The glass composition according to claim 1, wherein said glass is a borosilicate glass with the following composition in weight-%:

| | |
|---|---|
| SiO₂ | 60-85; |
| Al₂O₃ | 0-10; |
| B₂O₃ | 5-20; |
| Sum Li₂O + Na₂O + K₂O | 2-16; |
| Sum MgO + CaO + SrO + BaO + ZnO | 0-15; |
| Sum TiO₂ + ZrO₂ | 0-5; and |
| P₂O₅ | 0-2. |

23. The glass composition according to claim 22, wherein said borosilicate glass has the following composition in weight-%:

| | |
|---|---|
| SiO₂ | 63-84; |
| Al₂O₃ | 0-8; |
| B₂O₃ | 5-18; |
| Sum Li₂O + Na₂O + K₂O | 3-14; |
| Sum MgO + CaO + SrO + BaO + ZnO | 0-12; |
| Sum TiO₂ + ZrO₂ | 0-4; and |
| P₂O₅ | 0-2. |

24. The glass composition according to claim 23, wherein said borosilicate glass has the following composition in weight-%:

| | |
|---|---|
| SiO₂ | 63-83; |
| Al₂O₃ | 0-7; |
| B₂O₃ | 5-18; |
| Sum Li₂O + Na₂O + K₂O | 4-14; |
| Sum MgO + CaO + SrO + BaO + ZnO | 0-10; |
| Sum TiO₂ + ZrO₂ | 0-3; and |
| P₂O₅ | 0-2. |

25. The glass composition according to claim 1, wherein said glass is an alkali-aluminosilicate with the following composition in weight-%:

| | |
|---|---|
| SiO₂ | 40-75; |
| Al₂O₃ | 10-30; |
| B₂O₃ | 0-20; |
| Sum Li₂O + Na₂O + K₂O | 4-30; |
| Sum MgO + CaO + SrO + BaO + ZnO | 0-15; |
| Sum TiO₂ + ZrO₂ | 0-15; and |
| P₂O₅ | 0-10. |

26. The glass according to claim 25, wherein said alkali-aluminosilicate glass has the following composition in weight-%:

| | |
|---|---|
| SiO₂ | 50-70; |
| Al₂O₃ | 10-27; |
| B₂O₃ | 0-18; |
| Sum Li₂O + Na₂O + K₂O | 5-28; |
| Sum MgO + CaO + SrO + BaO + ZnO | 0-13; |
| Sum TiO₂ + ZrO₂ | 0-13; and |
| P₂O₅ | 0-9. |

27. The glass according to claim 26, wherein said alkali-aluminosilicate glass has the following composition in weight-%:

| | |
|---|---|
| SiO₂ | 55-68; |
| Al₂O₃ | 10-27; |
| B₂O₃ | 0-15; |
| Sum Li₂O + Na₂O + K₂O | 4-27; |
| Sum MgO + CaO + SrO + BaO + ZnO | 0-12; |
| Sum TiO₂ + ZrO₂ | 0-10; and |
| P₂O₅ | 0-8. |

28. The glass according to claim 1, wherein said glass is an aluminosilicate glass with low alkali content having the following composition in weight-%:

| | |
|---|---|
| SiO₂ | 50-75; |
| Al₂O₃ | 7-25; |
| B₂O₃ | 0-20; |
| Sum Li₂O + Na₂O + K₂O | 1-4; |
| Sum MgO + CaO + SrO + BaO + ZnO | 5-25; |
| Sum TiO₂ + ZrO₂ | 0-10; and |
| P₂O₅ | 0-5. |

29. The glass according to claim 28, wherein said aluminosilicate glass with low alkali content has the following composition in weight-%:

| | |
|---|---|
| SiO₂ | 52-73; |
| Al₂O₃ | 7-23; |
| B₂O₃ | 0-18; |
| Sum Li₂O + Na₂O + K₂O | 1-4; |
| Sum MgO + CaO + SrO + BaO + ZnO | 5-23; |
| Sum TiO₂ + ZrO₂ | 0-10; and |
| P₂O₅ | 0-5. |

30. The glass according to claim 29, wherein said aluminosilicate glass with low alkali content has the following composition in weight-%:

| | |
|---|---|
| SiO₂ | 53-71; |
| Al₂O₃ | 7-22; |
| B₂O₃ | 0-18; |
| Sum Li₂O + Na₂O + K₂O | 1-4; |
| Sum MgO + CaO + SrO + BaO + ZnO | 5-22; |
| Sum TiO₂ + ZrO₂ | 0-8; and |
| P₂O₅ | 0-5. |

31. The glass according to claim 1, wherein said glass comprises at least one of:
at least one of Nd₂O₃, Fe₂O₃, CoO, NiO, V₂O₅, MnO₂, TiO₂, CuO, CeO₂, Cr₂O₃ as a coloring oxide; and
0-2 weight-% of at least one of As₂O₃, Sb₂O₃, SnO₂, SO₃, Cl, F, and CeO₂ as a refining agent.

32. The glass according to claim 1, wherein said glass one of:
is one of a layer and a plate and a size of said layer or plate is at least 10×10 mm²; and
is a glass roll having a width of at least 200 mm and an unwound length of said glass roll is at least 1 m.

33. The glass according to claim 1, wherein said glass is one of a glass layer and a plate, said one of a glass layer and a plate at least one of:
having a thickness of less than 0.1 mm, a CS of between 100 MPa and 600 MPa, a DoL of 20 μm or less and a CT of 120 MPa or less;
having a thickness of 75 μm or less, a CS between 100 MPa and 400 MPa, a DoL of 15 μm or less and a CT of 120 MPa or less;
having a thickness of less than 50 μm, a CS between 100 MPa and 350 MPa, a DoL of less than 10 μm and a CT of less than 120 MPa;
having a thickness of 25 μm or less, a CS between 100 MPa and 350 MPa, a DoL of 5 μm or less and a CT of 120 MPa or less; and
having a thickness of 10 μm or less, a CS between 100 MPa and 350 MPa, a DoL of 3 μm or less and a CT of 120 MPa or less.

34. The glass according to claim 1, wherein said glass has a bending radius of 300 mm or less.

35. A method for producing a coated, chemically strengthened flexible thin glass, comprising:
manufacturing a thin glass by at least one of the following: reducing a thicker glass by removing material, reducing a thicker glass by grinding, etching a thicker glass, downdrawing said glass, overflow fusion, floating said glass, and redrawing said glass;
chemically strengthening said glass; and
applying an adhesion promoting layer onto said glass one of before and after said chemical strengthening.

36. The method according to claim 35, further comprising applying at least one functional layer onto said glass.

37. The method according to claim 35, further comprising separating said glass into smaller individual pieces, wherein said separating comprises one of:
working at least one relief into at least one side of said glass prior to said chemical strengthening and separating said glass along said at least one relief into smaller entities after said chemical strengthening; and
heating said chemically strengthened glass along at least one line to a temperature above a glass transition temperature T_{g} of said glass and subsequently separating said glass along said at least one line into smaller entities.

38. The method according to claim 37, wherein said separating comprises said heating and said temperature is above an upper annealing temperature of said glass.
